(19) United States
(12) Patent Application Publication
(10) Pub. No.: US 2026/0252573 A1
(43) Pub. Date: Aug. 27, 2026

(54) SYSTEM

(71) Applicant: SoftBank Group Corp., Tokyo (JP)

(72) Inventor: Shuhei YOSHIKAWA, Tokyo (JP)

(73) Assignee: SoftBank Group Corp., Tokyo (JP)

(21) Appl. No.: 19/541,405

(22) Filed: Feb. 17, 2026

(30) Foreign Application Priority Data
Feb. 21, 2025 (JP) 2025-027028

(51) Int. Cl. G06F 16/2457; G06F 16/29; G06Q 10/40

(52) U.S. Cl. CPC G06F 16/24578; G06F 16/29; G06Q 10/40

(57) ABSTRACT

The system according to the embodiment comprises a receiving unit, an evaluation unit, a providing unit, a reliability evaluation unit, and a display unit. The receiving unit receives information shared by a user. The evaluation unit evaluates the reliability of the information received by the receiving unit. The providing unit provides a warning or supplementary information based on the information evaluated by the evaluation unit. The reliability evaluation unit evaluates the reliability and credibility of news sources. The display unit preferentially displays reliable information evaluated by the reliability evaluation unit.

### CROSS-REFERENCE TO RELATED APPLICATION

The present application claims priority to and incorporates by reference the entire contents of Japanese Patent Application No. 2025-027028 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, the reliability of information shared by users has not been sufficiently evaluated, and appropriate warnings or supplementary information have not been adequately provided, leaving room for improvement.

### SUMMARY OF THE INVENTION

The system according to the embodiment comprises a receiving unit, an evaluation unit, a providing unit, a reliability evaluation unit, and a display unit. The receiving unit receives information shared by a user. The evaluation unit evaluates the reliability of the information received by the receiving unit. The providing unit provides a warning or supplementary information based on the information evaluated by the evaluation unit. The reliability evaluation unit evaluates the reliability and credibility of news sources. The display unit preferentially displays reliable information evaluated by the reliability evaluation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

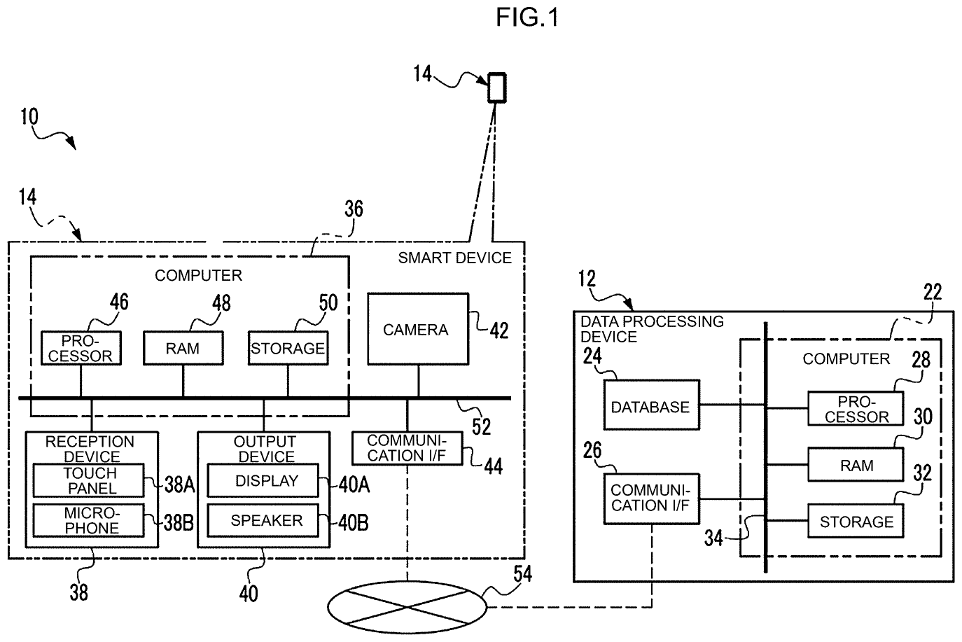

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

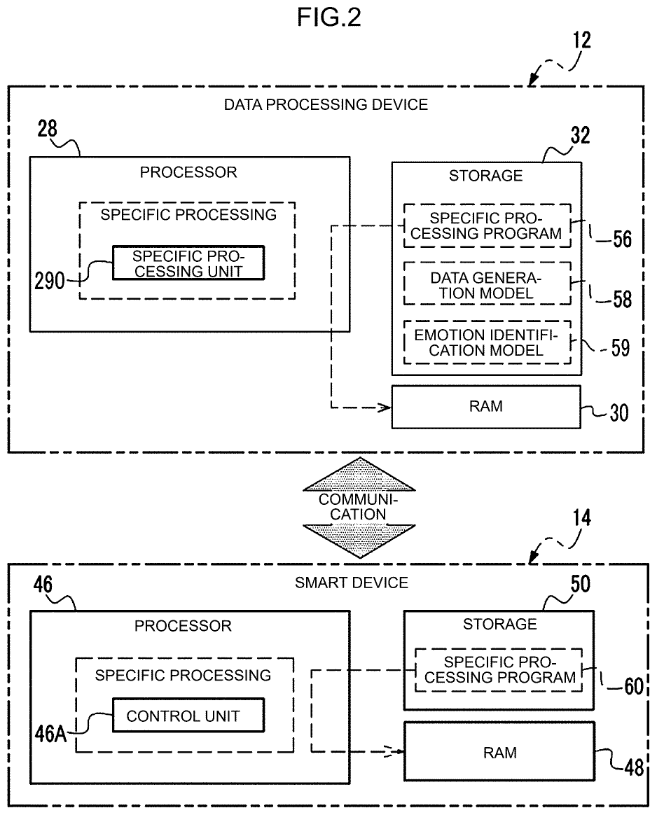

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system that collaborates with social media platforms, and when a user shares suspicious information, a generative AI automatically responds and provides warnings or supplementary information regarding the reliability of the information. This system prevents the spread of fake news by having the generative AI evaluate the reliability and credibility of news sources and generate information based on information that has been fact-checked in advance or highly reliable media. For example, when a user shares suspicious information on a social media platform, the information is sent to the generative AI. The generative AI evaluates the reliability of the information and provides warnings or supplementary information as necessary. For instance, if the information shared by the user is of low reliability, the generative AI displays a warning such as “This information may have low reliability.” Furthermore, by providing supplementary information from highly reliable sources, the user is enabled to obtain accurate information. Next, the generative AI evaluates the reliability and credibility of news sources. The generative AI generates information based on information that has been fact-checked in advance or highly reliable media. For example, the generative AI preferentially displays information from highly reliable news sources to prevent the spread of fake news. As a result, users can obtain highly reliable information and are less likely to be affected by fake news. Through this mechanism, the reliability of information on social media platforms is improved, and the spread of fake news can be prevented. By referring to warnings and supplementary information provided by the generative AI, users can obtain accurate information and improve their ability to judge the reliability of information. Thus, the system collaborating with social media platforms can prevent the spread of fake news by evaluating the reliability of information shared by users and providing warnings or supplementary information. Specifically, the system acquires user post data (e.g., text data, image data, video data, link URLs, etc.) in real time via the API of the social media platform, performs normalization, tokenization, and feature extraction (e.g., contextual vectorization using a BERT-series encoder for text, feature map extraction using CNN for images) in a preprocessing unit, and inputs the data to a generative AI (for example, a pre-trained large language model or multimodal model). The generative AI accepts input data such as “User post text: ‘XX went bankrupt today’”, “Image: screenshot of a news article”, “Link: external news site URL”, etc. The AI model outputs (1) reliability score (e.g., continuous value from 0.12 to 0.98), (2) reliability label (e.g., high, medium, low), (3) summary text and source list for supplementary information generation, (4) warning message text (e.g., “This information has been judged as incorrect in past fact checks”), etc. Internally, the AI model applies a multi-layer self-attention mechanism to the input sequence using a Transformer architecture and matches it against a pre-constructed reliability evaluation database (e.g., a set of embedding vectors of fact-checked articles, a list of news sources with reliability scores). The model calculates semantic similarity (e.g., cosine similarity) between the input information and known information in the database, and if the threshold (e.g., 0.85 or higher) is exceeded, it judges the information as “known misinformation” and generates a warning message. Furthermore, if the reliability score is low, the model automatically searches for the latest related information from highly reliable sources (e.g., public institutions, major news organizations), summarizes and cites it, and presents it as supplementary information. These outputs are sent to subsequent warning display units and supplementary information presentation units and are displayed in real time on the user interface. As a technical effect, this system, unlike conventional methods where humans manually investigate the authenticity of information one by one, greatly improves processing speed and reduces misjudgment rates by performing automatic matching, scoring, and generation in a high-dimensional vector space for a vast amount of information flow, thereby technically improving information reliability management. In addition, the AI model can be trained using supervised learning (e.g., minimizing cross-entropy loss with reliability-labeled datasets) and continual learning (sequential addition of new fake news cases), allowing flexible adaptation to chronological changes in information. Application fields include general SNS platforms, news aggregators, enterprise information sharing infrastructure, and information literacy support systems for educational institutions. Through these configurations, the present invention achieves not only automation of human tasks but also an essential improvement in computer technology by enabling unconventional information matching, generation, and warning presentation in a high-dimensional feature space by AI.

The system according to the embodiment comprises a receiving unit, an evaluation unit, a providing unit, a reliability evaluation unit, and a display unit. The receiving unit receives information shared by a user. For example, the receiving unit can receive information such as text, images, and videos posted by users on social media platforms. The evaluation unit uses a generative AI to evaluate the reliability of the information received by the receiving unit. For example, the evaluation unit calculates a reliability score of the information source and evaluates the reliability of the information based on the score. The evaluation unit can also refer to the past reliability history of the information source using generative AI to improve the accuracy of the evaluation. The providing unit provides warnings or supplementary information based on the information evaluated by the evaluation unit. For example, the providing unit displays a warning such as “This information may have low reliability.” The providing unit can also provide supplementary information from highly reliable information sources. The reliability evaluation unit uses generative AI to evaluate the reliability and credibility of news sources. For example, the reliability evaluation unit evaluates the reliability and credibility of news sources based on information that has been fact-checked in advance or highly reliable media. The reliability evaluation unit can also refer to the past reliability history of news sources using generative AI to improve the accuracy of the evaluation. The display unit preferentially displays highly reliable information evaluated by the reliability evaluation unit. For example, the display unit preferentially displays information from highly reliable news sources. The display unit can also use generative AI to estimate the user's emotion and adjust the display method based on the estimated emotion. Thus, the system according to the embodiment can prevent the spread of fake news by evaluating the reliability of information shared by users and providing warnings or supplementary information. Specifically, the system acquires user post data (e.g., text data, image data, video data, link URLs, etc.) in real time via the API of the social media platform in the receiving unit, performs normalization, tokenization, and feature extraction (e.g., contextual vectorization using a BERT-series encoder for text, feature map extraction using CNN for images) in a preprocessing unit, and sends the data to the evaluation unit. The evaluation unit utilizes large language models and multimodal models based on Transformer architecture and accepts input data such as “User post text: ‘XX went bankrupt today’”, “Image: screenshot of a news article”, “Link: external news site URL”, etc. The evaluation unit outputs (1) reliability score (e.g., continuous value from 0.12 to 0.98), (2) reliability label (e.g., high, medium, low), (3) summary text and source list for supplementary information generation, (4) warning message text (e.g., “This information has been judged as incorrect in past fact checks”), etc. Internally, the AI model applies a multi-layer self-attention mechanism to the input sequence and matches it against a pre-constructed reliability evaluation database (e.g., a set of embedding vectors of fact-checked articles, a list of news sources with reliability scores). The model calculates semantic similarity (e.g., cosine similarity) between the input information and known information in the database, and if the threshold (e.g., 0.85 or higher) is exceeded, it judges the information as “known misinformation” and generates a warning message. Furthermore, if the reliability score is low, the model automatically searches for the latest related information from highly reliable sources (e.g., public institutions, major news organizations), summarizes and cites it, and presents it as supplementary information. These outputs are sent to subsequent providing units and display units and are displayed in real time on the user interface. The display unit performs sentiment analysis (e.g., classification into positive, negative, neutral, or scoring of emotional intensity) on the post text to estimate the user's emotion and automatically switches the display method (e.g., color coding, emphasis, adjustment of detail level) according to the estimation result. As a technical effect, this system, unlike conventional methods where humans manually investigate the authenticity of information one by one, greatly improves processing speed and reduces misjudgment rates by performing automatic matching, scoring, and generation in a high-dimensional vector space for a vast amount of information flow, thereby technically improving information reliability management. In addition, the AI model can be trained using supervised learning (e.g., minimizing cross-entropy loss with reliability-labeled datasets) and continual learning (sequential addition of new fake news cases), allowing flexible adaptation to chronological changes in information. Application fields include general SNS platforms, news aggregators, enterprise information sharing infrastructure, and information literacy support systems for educational institutions. Through these configurations, the present invention achieves not only automation of human tasks but also an essential improvement in computer technology by enabling unconventional information matching, generation, and warning presentation in a high-dimensional feature space by AI.

The evaluation unit can calculate a reliability score of an information source and evaluate the reliability of the information based on the score. For example, the evaluation unit uses a scoring algorithm to calculate the reliability score of the information source. The scoring algorithm calculates the score based on evaluation items such as the credibility of the information source and its past performance. For example, the evaluation unit can refer to the past reliability history of the information source to evaluate its credibility. The evaluation unit can also use generative AI to calculate the reliability score of the information source. For example, the evaluation unit inputs the reliability evaluation of the information source to the generative AI, which then calculates the score. Thus, the evaluation unit can calculate a reliability score of the information source and evaluate the reliability of the information based on the score. Specifically, the evaluation unit receives user post data (e.g., text data, image data, video data, link URLs, etc.) acquired via the API of the social media platform, normalizes, tokenizes, and extracts features in a preprocessing unit, and inputs these as high-dimensional vectors to the generative AI. The evaluation unit utilizes large language models and multimodal models based on Transformer architecture and accepts input data such as “User post text: ‘XX went bankrupt today’”, “Image: screenshot of a news article”, “Link: external news site URL”, etc. The AI model applies a multi-layer self-attention mechanism to the input sequence and matches it against a pre-constructed reliability evaluation database (e.g., a set of embedding vectors of fact-checked articles, a list of news sources with reliability scores). Input examples include “Post text: ‘Company YY announced a new product’”, “Image: photo of the event site”, “Link: public institution announcement page”, etc. The AI model outputs (1) reliability score (e.g., continuous value from 0.12 to 0.98), (2) reliability label (e.g., high, medium, low), (3) summary text and source list for supplementary information generation, etc. Output examples include “Reliability score: 0.92”, “Reliability label: high”, “Summary: matches the announcement by a public institution”, “Source: official government site”, etc. The AI model calculates semantic similarity (e.g., cosine similarity) between the input information and known information in the database, and if the threshold (e.g., 0.85 or higher) is exceeded, it judges the information as “known misinformation” and generates a warning message. If the reliability score is low, the model automatically searches for the latest related information from highly reliable sources, summarizes and cites it, and presents it as supplementary information. These outputs are sent to subsequent warning display units and supplementary information presentation units and are displayed in real time on the user interface. The AI model can be trained using supervised learning (e.g., minimizing cross-entropy loss with reliability-labeled datasets) and continual learning (sequential addition of new fake news cases). As a technical effect, the evaluation unit, unlike conventional methods where humans manually investigate the authenticity of information one by one, greatly improves processing speed and reduces misjudgment rates by performing automatic matching, scoring, and generation in a high-dimensional vector space for a vast amount of information flow, thereby technically improving information reliability management. Application fields include SNS platforms, news aggregators, enterprise information sharing infrastructure, and information literacy support systems for educational institutions. Thus, the evaluation unit achieves not only automation of human tasks but also an essential improvement in computer technology by enabling unconventional information matching and scoring in a high-dimensional feature space by AI.

The providing unit can display warnings such as “This information has low reliability.” For example, the providing unit displays warnings for information with low reliability. The specific content and display method of the warning are determined by the generative AI. For example, the providing unit can use generative AI to generate the content of the warning message. The warning message is displayed based on the reliability score of the information. For example, the providing unit displays a warning such as “This information has low reliability” for information with a low reliability score. The providing unit can also adjust the timing of displaying the warning message. For example, the providing unit can display a warning before the user shares the information. Thus, by displaying warnings for information with low reliability, the providing unit can alert the user. Specifically, the providing unit inputs the reliability score and reliability label (e.g., 0.23, low) received from the evaluation unit to the warning message generation module. Input examples include “Reliability score: 0.23”, “Reliability label: low”, “Post content: ‘XX went bankrupt today’”, etc. The generative AI receives these inputs and outputs warning message text (e.g., “This information has been judged as incorrect in past fact checks”, “This information has low reliability”). Output examples include “Warning message: This information has low reliability”, “Warning message: This information may be misinformation”, etc. The timing of displaying the warning message is automatically controlled according to the system state, such as immediately before the user presses the post button or when the post is displayed in the feed after posting. The warning message is emphasized on the user interface (e.g., red background, icon attachment, popup display) to draw the user's attention. Internally, the AI model utilizes similarity calculation with past warning case databases, template selection, and natural language generation (NLG) technology for warning text generation. The content and expression method of the warning message may also be automatically adjusted according to the user's estimated emotion or device information. As a technical effect, the providing unit, unlike conventional static warning display, performs dynamic warning generation and display control by AI, thereby enhancing the deterrence against the spread of misinformation without impairing the user experience and technically improving the soundness of information flow. Application fields include SNS, news distribution services, enterprise information sharing systems, and information literacy support for educational institutions. Thus, the providing unit achieves an improvement in computer technology by enabling AI-based warning generation and display control, and can automatically provide appropriate alerts to users.

The providing unit can provide supplementary information from highly reliable information sources. For example, the providing unit provides supplementary information from highly reliable information sources. The specific content and provision method of the supplementary information are determined by the generative AI. For example, the providing unit can use generative AI to generate the content of the supplementary information. The supplementary information is obtained from highly reliable information sources. For example, the providing unit provides information from sources with high reliability scores as supplementary information. The providing unit can also adjust the timing of providing supplementary information. For example, the providing unit can provide supplementary information after the user has shared the information. Thus, by providing supplementary information from highly reliable information sources, the providing unit enables users to obtain accurate information. Specifically, the providing unit inputs the reliability score and reliability label (e.g., 0.92, high) received from the evaluation unit, along with the post content, to the supplementary information generation module. Input examples include “Reliability score: 0.92”, “Reliability label: high”, “Post content: ‘Company YY announced a new product’”, etc. The generative AI receives these inputs, automatically searches for the latest related information from highly reliable sources (e.g., public institutions, major news organizations, academic papers), summarizes and cites it, and outputs supplementary information text (e.g., “According to the announcement by a public institution, Company YY announced a new product today”). Output examples include “Supplementary information: matches the announcement on the official government site”, “Supplementary information: consistent with major news organization reports”, etc. The timing of providing supplementary information is automatically controlled according to the system state, such as immediately after the user completes the post or when other users view the relevant information. Supplementary information is emphasized on the user interface (e.g., blue background, quotation frame, detailed link attachment) to make it easy for users to refer to accurate information. Internally, the AI model utilizes semantic similarity calculation with the reliability evaluation database, summary generation, source list extraction, and natural language generation (NLG) technology for supplementary information generation. The content and level of detail of the supplementary information may also be automatically adjusted according to the importance of the information or the user's estimated emotion. As a technical effect, the providing unit, unlike conventional static supplementary information presentation, performs dynamic supplementary information generation and display control by AI, enabling users to quickly access accurate and highly reliable information and technically improving the reliability and transparency of information flow. Application fields include SNS, news distribution services, enterprise information sharing systems, and information literacy support for educational institutions. Thus, the providing unit achieves an improvement in computer technology by enabling AI-based supplementary information generation and display control, and can automatically provide accurate information to users.

The reliability evaluation unit can evaluate the reliability and credibility of news sources based on information that has been fact-checked in advance or reliable media. For example, the reliability evaluation unit evaluates the reliability and credibility of news sources based on information that has been fact-checked in advance or highly reliable media. The reliability evaluation unit can use generative AI to perform reliability evaluation of news sources. For example, the reliability evaluation unit inputs the reliability evaluation of news sources to the generative AI, which then performs the evaluation. The reliability evaluation unit needs to clarify the specific methods and criteria for fact-checking. For example, the reliability evaluation unit clarifies the procedures for fact-checking and the databases used. The reliability evaluation unit also needs to clarify the specific criteria and identification methods for reliable media. For example, the reliability evaluation unit clarifies the threshold for reliability scores and evaluation items. Thus, the reliability evaluation unit can evaluate the reliability and credibility of news sources based on information that has been fact-checked in advance or highly reliable media. Specifically, the reliability evaluation unit receives structured data such as news source URLs, media names, and publisher information as input. Input examples include “News source URL: https://example.com/news/123”, “Media name: Major News Organization A”, “Publication date: 2023-12-01”, etc. The reliability evaluation unit matches these inputs against a pre-constructed fact-checked information database (e.g., a set of embedding vectors of verified articles, a list of media with reliability scores), refers to semantic similarity (e.g., cosine similarity), and the publisher's past reliability history. The AI model calculates similarity between the input information and known information in the database, and if the threshold (e.g., 0.85 or higher) is exceeded, it judges the information as “known misinformation” or “high reliability information.” Output examples include “Reliability score: 0.95”, “Reliability label: high”, “Evaluation basis: no errors in the past 10 fact checks”, etc. The fact-checking procedure includes (1) normalization of input information, (2) vector similarity calculation with known information, (3) reliability score calculation, (4) extraction of evaluation basis, and (5) structured output of results. Criteria for reliable media include combining multiple items such as past error rates, third-party certification, publication frequency, and citation record for scoring. The AI model can be trained using supervised learning (e.g., minimizing cross-entropy loss with reliability-labeled news source datasets) and continual learning (sequential addition of new news sources). As a technical effect, the reliability evaluation unit, unlike conventional manual fact-checking or static media list referencing, performs automatic matching, scoring, and basis extraction in a high-dimensional feature space by AI, greatly improving evaluation accuracy and processing speed, and technically improving information reliability management. Application fields include SNS, news distribution services, enterprise information sharing systems, and information literacy support for educational institutions. Thus, the reliability evaluation unit achieves an improvement in computer technology by enabling AI-based fact-checking and reliability evaluation, and can objectively and efficiently evaluate the reliability of news sources.

The display unit can preferentially display information from highly reliable news sources. For example, the display unit preferentially displays information from highly reliable news sources. The display unit can use generative AI to determine the priority of information to be displayed. For example, the display unit inputs the priority of information to be displayed to the generative AI, which then determines the priority. The display unit needs to clarify the criteria and methods for determining the priority and the specific criteria and identification methods for highly reliable news sources. For example, the display unit clarifies the method for determining display order and the criteria for setting priority, as well as the threshold for reliability scores and evaluation items. Thus, the display unit can preferentially display information from highly reliable news sources. Specifically, the display unit inputs the reliability score and reliability label (e.g., 0.95, high) received from the reliability evaluation unit or evaluation unit, along with the post content, to the display priority determination module. Input examples include “Reliability score: 0.95”, “Reliability label: high”, “News source: Major News Organization A”, etc. The generative AI receives these inputs and outputs display order (e.g., 1st, 2nd, 3rd) and display method (e.g., emphasis, color coding, adjustment of detail level). Output examples include “Display order: 1st”, “Display method: emphasis (blue background)”, etc. The display unit preferentially displays information with reliability scores above the threshold (e.g., 0.85) at the top, and information below the threshold is displayed lower or not displayed. The method for determining display order combines multiple items such as reliability score, novelty of information, user's field of interest, and importance of information for scoring. Internally, the AI model utilizes multivariate optimization algorithms that combine input information, user profiles, and past display history. Criteria for highly reliable news sources include past error rates, third-party certification, publication frequency, and citation record. As a technical effect, the display unit, unlike conventional static display order control, performs dynamic display order determination and display method adjustment by AI, enabling users to quickly and intuitively access highly reliable information and technically improving the reliability of information flow and user experience. Application fields include SNS, news distribution services, enterprise information sharing systems, and information literacy support for educational institutions. Thus, the display unit achieves an improvement in computer technology by enabling AI-based display order determination and display method adjustment, and can automatically provide optimal information presentation to users.

The receiving unit can estimate the user's emotion and adjust the timing of receiving information based on the emotion. For example, the receiving unit estimates the user's emotion and adjusts the timing of receiving information based on the estimated emotion. Emotion estimation is realized using an emotion engine or generative AI, such as a text generative AI (e.g., LLM) or multimodal generative AI, but is not limited to these examples. For instance, if the user is excited, the receiving unit temporarily delays receiving the information and receives it after the user has calmed down. If the user is calm, the receiving unit receives the information immediately and promptly starts processing. If the user is anxious, the receiving unit can display a reassuring message before receiving the information. Thus, by adjusting the timing of receiving information according to the user's emotion, the receiving unit can receive information at a more appropriate timing. Specifically, before sending user post data (e.g., text data, image data, video data, link URLs, etc.) acquired via the API of the social media platform to the preprocessing unit, the receiving unit activates an emotion estimation module to estimate the user's emotional state. The emotion estimation module accepts multidimensional feature vectors (e.g., numerical arrays of length 128 to 512) as input, such as user post text (e.g., “Company YY announced a new product today”), frequency of emojis and exclamation marks at the time of posting, posting time, past posting history, and user reaction history (e.g., likes, shares, comment content). The AI model uses a BERT-series encoder or multimodal Transformer to integratively process text, images, and metadata. Input examples include “Post text: ‘Company YY announced a new product’”, “Emoji: [symbol] ”, “Posting time: 23:45”, “Past post emotion score: 0.85 (excited)”, etc. The AI model outputs emotion labels (e.g., excited, calm, anxious) and emotion intensity scores (e.g., continuous value from 0.12 to 0.98). Output examples include “Emotion label: excited”, “Emotion intensity: 0.91”, “Estimation basis: frequent use of emojis and exclamation marks”, etc. The receiving unit sends a signal to the information receiving timing control module according to the emotion estimation result. For example, if “Emotion label: excited” and “Emotion intensity: 0.91”, the receiving timing is delayed by 30 seconds, and a message such as “Please review your post after calming down” is displayed during the delay. If “Emotion label: calm”, information is received immediately; if “Emotion label: anxious”, a supportive message such as “Please post with confidence” is displayed before receiving. Internally, the AI model has a multi-layer self-attention mechanism and an output head for emotion classification, and is trained using supervised learning (minimizing cross-entropy loss) with emotion-labeled post datasets (e.g., pairs of SNS posts and emotion annotations). In subsequent processing, the emotion estimation result is linked not only to receiving timing control but also to reliability evaluation and warning generation for the post content. As a technical effect, the receiving unit, unlike conventional methods where humans subjectively judge emotions and adjust posting timing, realizes emotion estimation and dynamic receiving timing control in a high-dimensional feature space by AI, thereby suppressing impulsive spread of misinformation and technically improving the soundness of information flow and user experience. Application fields include SNS platforms, news distribution services, enterprise information sharing infrastructure, and information literacy support systems for educational institutions. Thus, the receiving unit achieves an improvement in computer technology by enabling AI-based emotion estimation and receiving timing control, and can automatically perform optimal information reception according to the user's psychological state.

The receiving unit can analyze the user's past information sharing history and select an appropriate receiving method. For example, the receiving unit analyzes the user's past information sharing history and selects the optimal receiving method based on the history. The receiving unit can use generative AI to analyze the user's past information sharing history. For example, the receiving unit inputs the user's past information sharing history to the generative AI, which then selects the optimal receiving method. The receiving unit can analyze the types of information frequently shared by the user in the past and propose a receiving method according to the type. For example, if the user frequently shared text information in the past, the receiving unit preferentially proposes a receiving method for text information. The receiving unit can also preferentially propose sharing methods (text, images, links, etc.) that the user has used frequently in the past. For example, if the user frequently shared images in the past, the receiving unit preferentially proposes a receiving method for images. The receiving unit can also propose the optimal receiving method for specific time periods based on the user's past sharing history. For example, if the user frequently shared information during a specific time period in the past, the receiving unit proposes the optimal receiving method for that time period. Thus, by analyzing the user's past information sharing history, the receiving unit can select the optimal receiving method. Specifically, the receiving unit refers to an information sharing history database accumulated for each user (e.g., structured data including types of posts, posting times, posting devices, content categories over the past year), normalizes, categorizes, and converts these history data into time series vectors (e.g., converting each post into a 128-dimensional feature vector and storing as a time series array) in a preprocessing unit, and inputs them to a history analysis AI model. The AI model uses a time series analysis network based on LSTM or Transformer to extract the user's posting tendencies and behavioral patterns by time period. Input examples include “Past post types: text 80%, images 15%, links 5%”, “Posting time period: mostly 18:00 to 22:00”, “Device: smartphone 90%, PC 10%”, etc. The AI model outputs the optimal receiving method (e.g., text-priority reception, image-priority reception, time period-based reception recommendation), reason for recommendation (e.g., based on past posting tendencies), and interface customization proposals (e.g., emphasizing the image upload button). Output examples include “Recommended receiving method: text priority”, “Recommended time period: 18:00 to 22:00”, “Interface: place image upload button at the top”, etc. The receiving unit dynamically changes the user interface based on the AI model's output and automatically presents the most user-friendly receiving method. The AI model can be trained using supervised learning with paired data of user behavior history and receiving method selection results, or clustering for user type classification. In subsequent processing, the receiving method selection result is linked to preprocessing of post content and the reliability evaluation flow. As a technical effect, the receiving unit, unlike conventional static receiving interfaces, realizes history analysis and dynamic receiving method optimization by AI, thereby providing a reception experience tailored to each user's behavioral characteristics, reducing posting errors and operational stress, and technically improving the efficiency and accuracy of information flow. Application fields include SNS platforms, news distribution services, enterprise information sharing infrastructure, and information literacy support systems for educational institutions. Thus, the receiving unit achieves an improvement in computer technology by enabling AI-based history analysis and receiving method optimization, and can automatically perform information reception optimized for each user.

The receiving unit can perform filtering based on the user's current field of interest at the time of receiving information. For example, the receiving unit performs filtering based on the user's current field of interest at the time of receiving information. The receiving unit can use generative AI to identify the user's current field of interest and filter information based on that field. For example, the receiving unit inputs the user's current field of interest to the generative AI, which then filters information based on the field. The receiving unit can preferentially receive only information related to topics the user is currently interested in. For example, the receiving unit preferentially receives information containing keywords related to topics the user is currently interested in. The receiving unit can also filter out information with low relevance based on the user's field of interest. For example, the receiving unit filters information unrelated to the user's field of interest. Thus, by filtering information based on the user's current field of interest, the receiving unit can preferentially receive highly relevant information. Specifically, the receiving unit collects various behavioral data such as the user's recent posting history, browsing history, search queries, and click history, normalizes, tokenizes, and extracts features (e.g., contextual vectorization using a BERT-series encoder, topic estimation using a category classifier) in a preprocessing unit, and inputs them to an AI model for field of interest estimation. The AI model uses a Transformer-based multi-class classification network or a time series model (e.g., LSTM) that inputs user behavior sequences to estimate the user's current field of interest (e.g., sports, economy, technology, etc.). Input examples include “Recent post: ‘Announcement of new smartphone’”, “Browsing history: 10 technology articles”, “Search query: AI technology”, “Click history: gadget reviews”, etc. The AI model outputs field of interest labels (e.g., technology, sports, politics), interest score (e.g., 0.87), and related keyword list (e.g., AI, smartphone, 5G). Output examples include “Field of interest: technology”, “Interest score: 0.92”, “Related keywords: AI, IoT, smartphone”, etc. The receiving unit preferentially receives information matching the field of interest at the time of posting based on the AI model's output, and excludes or displays warnings for information with low relevance. The AI model can be trained using supervised learning with paired user behavior data and field of interest annotations, or clustering for automatic extraction of fields of interest. In subsequent processing, the field of interest filtering result is linked to reliability evaluation and warning generation for the post content. As a technical effect, the receiving unit, unlike conventional static category selection or manual filtering, realizes dynamic field of interest estimation and information reception filtering by AI, thereby promoting information flow tailored to the user's interests, suppressing the inflow of noise information, and technically improving the relevance of information and user experience. Application fields include SNS platforms, news distribution services, enterprise information sharing infrastructure, and information literacy support systems for educational institutions. Thus, the receiving unit achieves an improvement in computer technology by enabling AI-based field of interest estimation and information filtering, and can automatically perform optimal information reception for users.

The receiving unit can estimate the user's emotion and determine the priority of information to be received based on the emotion. For example, the receiving unit estimates the user's emotion and determines the priority of information to be received based on the estimated emotion. Emotion estimation is realized using an emotion engine or generative AI, such as a text generative AI (e.g., LLM) or multimodal generative AI, but is not limited to these examples. For instance, if the user is excited, the receiving unit preferentially receives information of high importance. If the user is calm, the receiving unit receives information in the normal priority order. If the user is anxious, the receiving unit preferentially receives information that provides reassurance. Thus, by determining the priority of information according to the user's emotion, the receiving unit can preferentially receive important information. Specifically, the receiving unit inputs user post data (e.g., text, images, videos, links, etc.) along with the user's recent behavior history and posting metadata (e.g., posting time, presence of emojis and exclamation marks, past emotion scores) to an emotion estimation module. The emotion estimation module uses a BERT-series encoder or multimodal Transformer to output emotion labels (e.g., excited, calm, anxious) and emotion intensity scores (e.g., 0.12 to 0.98) from the input data. Input examples include “Post text: ‘XX went bankrupt today’”, “Emoji: [symbol] ”, “Emotion intensity: 0.93 (excited)”, etc. The AI model combines the emotion estimation result with the importance score of the post content (e.g., information category, past dissemination record, reliability score) and inputs them to a priority determination module. The priority determination module preferentially receives information of high importance (e.g., news with significant social impact, urgent information) when the emotion state is “excited”, receives information in the normal priority order when “calm”, and preferentially receives information that provides reassurance (e.g., public institution announcements, FAQs) when “anxious”. Output examples include “Priority: 1st (social news)”, “Priority: 2nd (FAQ)”, “Priority: 3rd (entertainment)”, etc. The receiving unit automatically rearranges or emphasizes reception candidates on the user interface according to the priority based on the AI model's output. The AI model can be trained using supervised learning with paired data of emotion state, post content, and priority selection results. In subsequent processing, the priority determination result is linked to reliability evaluation and warning generation for the post content. As a technical effect, the receiving unit, unlike conventional static reception order control, realizes emotion estimation and dynamic priority determination by AI, thereby promoting information flow tailored to the user's psychological state and information importance, reducing the risk of misinformation spread and information oversight, and technically improving the efficiency of information flow and user experience. Application fields include SNS platforms, news distribution services, enterprise information sharing infrastructure, and information literacy support systems for educational institutions. Thus, the receiving unit achieves an improvement in computer technology by enabling AI-based emotion estimation and priority determination, and can automatically perform optimal information reception for users.

The receiving unit can preferentially receive highly relevant information by considering the user's geographic location information at the time of receiving information. For example, the receiving unit preferentially receives highly relevant information by considering the user's geographic location information at the time of receiving information. The receiving unit can use generative AI to identify the user's geographic location information and filter information based on that location. For example, the receiving unit inputs the user's geographic location information to the generative AI, which then filters information based on the location. The receiving unit can preferentially receive information related to the region where the user is currently located. For example, the receiving unit preferentially receives news or event information related to the region where the user is currently located. The receiving unit can also filter out information with low relevance based on the user's geographic location information. For example, the receiving unit filters information unrelated to the user's current location. Thus, by considering the user's geographic location information, the receiving unit can preferentially receive highly relevant information. Specifically, the receiving unit accurately identifies the user's current location using GPS coordinates, IP address, Wi-Fi access point information, etc., obtained from the user device. These location data are processed in the preprocessing unit by geocoding (e.g., converting latitude and longitude to prefecture/city/town), vectorizing location information (e.g., one-hot vectorization by location category), and input to an AI model for location information filtering. The AI model uses a multi-class classification network for determining the relevance between location information and post content, or a location-embedded information recommendation model (e.g., location embedding+Transformer). Input examples include “User location: Chiyoda-ku, Tokyo”, “Post content: event information in Tokyo”, “Location category: urban area”, etc. The AI model outputs relevance score (e.g., 0.12 to 0.98), priority reception label (e.g., high, medium, low), and reason for recommendation (e.g., region match score 0.95). Output examples include “Relevance score: 0.93”, “Priority reception: high”, “Reason for recommendation: user location matches post content”, etc. The receiving unit preferentially receives information related to the user's current location based on the AI model's output, and excludes or displays warnings for information with low relevance. The AI model can be trained using supervised learning with paired location-tagged post data and relevance annotations, or geographic clustering for extracting regional characteristics. In subsequent processing, the location information filtering result is linked to reliability evaluation and warning generation for the post content. As a technical effect, the receiving unit, unlike conventional static region category selection or manual filtering, realizes dynamic location information estimation and information reception filtering by AI, thereby promoting region-specific information flow, suppressing the inflow of noise information, and technically improving the relevance of information and user experience. Application fields include regional SNS, local news distribution services, municipal information sharing infrastructure, and disaster information transmission systems. Thus, the receiving unit achieves an improvement in computer technology by enabling AI-based location information estimation and information filtering, and can automatically perform optimal information reception for users.

The receiving unit can analyze the user's social media activity at the time of receiving information and receive relevant information. For example, the receiving unit analyzes the user's social media activity at the time of receiving information and receives relevant information based on that activity. The receiving unit can use generative AI to analyze the user's social media activity. For example, the receiving unit inputs the user's social media activity to the generative AI, which then identifies relevant information. The receiving unit can preferentially receive information containing keywords related to topics frequently shared by the user on social media. The receiving unit can also filter out information with low relevance based on the user's social media activity. For example, the receiving unit filters information unrelated to the user's social media activity. Thus, by analyzing the user's social media activity, the receiving unit can preferentially receive relevant information. Specifically, the receiving unit acquires user behavior data such as past posting history, comment history, share history, like history, and attributes of followed accounts via the social media API, normalizes, tokenizes, and extracts features (e.g., contextual vectorization using a BERT-series encoder, topic estimation using a category classifier) in a preprocessing unit, and inputs them to an AI model for activity analysis. The AI model uses a time series model (e.g., LSTM, Transformer) that inputs user behavior sequences or a graph neural network (GNN) to extract the user's interests, topics, and behavioral patterns. Input examples include “Past posts: 10 technology articles”, “Share history: 5 sports news”, “Followed accounts: economic influencers”, etc. The AI model outputs related topic labels (e.g., technology, sports, economy), relevance score (e.g., 0.89), and recommended keyword list (e.g., AI, soccer, stock price). Output examples include “Related topic: technology”, “Relevance: 0.92”, “Recommended keywords: AI, IoT, smartphone”, etc. The receiving unit preferentially receives information matching the related topic at the time of posting based on the AI model's output, and excludes or displays warnings for information with low relevance. The AI model can be trained using supervised learning with paired user behavior data and related topic annotations, or graph structure analysis for extracting interest clusters. In subsequent processing, the activity analysis result is linked to reliability evaluation and warning generation for the post content. As a technical effect, the receiving unit, unlike conventional static category selection or manual filtering, realizes dynamic activity analysis and information reception filtering by AI, thereby promoting information flow tailored to the user's interests, suppressing the inflow of noise information, and technically improving the relevance of information and user experience. Application fields include SNS platforms, news distribution services, enterprise information sharing infrastructure, and information literacy support systems for educational institutions. Thus, the receiving unit achieves an improvement in computer technology by enabling AI-based activity analysis and information filtering, and can automatically perform optimal information reception for users.

The evaluation unit can estimate the user's emotion and adjust the criteria for evaluating the reliability of information based on the emotion. For example, the evaluation unit estimates the user's emotion and adjusts the criteria for evaluating the reliability of information based on the estimated emotion. Emotion estimation is realized using an emotion engine or generative AI, such as a text generative AI (e.g., LLM) or multimodal generative AI, but is not limited to these examples. For instance, if the user is excited, the evaluation unit applies strict reliability evaluation criteria. If the user is calm, the evaluation unit applies standard reliability evaluation criteria. If the user is anxious, the evaluation unit applies reliability evaluation criteria that provide reassurance. Thus, by adjusting the reliability evaluation criteria according to the user's emotion, the evaluation unit can perform more appropriate reliability evaluation. Specifically, the evaluation unit inputs user post data (e.g., text, images, videos, links, etc.) along with posting metadata (e.g., posting time, presence of emojis and exclamation marks, past emotion scores) to an emotion estimation module. The emotion estimation module uses a BERT-series encoder or multimodal Transformer to output emotion labels (e.g., excited, calm, anxious) and emotion intensity scores (e.g., 0.12 to 0.98) from the input data. Input examples include “Post text: ‘XX went bankrupt today’”, “Emoji: [symbol] ”, “Emotion intensity: 0.93 (excited)”, etc. The AI model inputs the emotion estimation result to a reliability evaluation criteria adjustment module, and, for example, raises the fact-checking threshold to 0.95 and applies additional strict evaluation items such as past error rates and third-party certification when the emotion is “excited”; applies the standard threshold (e.g., 0.85) and standard evaluation items when “calm”; and prioritizes public institutions and FAQs as highly reliable sources when “anxious” to provide reassurance. Output examples include “Applied evaluation criteria: strict (threshold 0.95, error rate reference)”, “Applied evaluation criteria: standard (threshold 0.85)”, “Applied evaluation criteria: reassurance-focused (public institution priority)”, etc. These criteria adjustments are linked to subsequent processing such as reliability score calculation, warning generation, and supplementary information presentation. The AI model can be trained using supervised learning with paired data of emotion state, criteria selection, and evaluation results. As a technical effect, the evaluation unit, unlike conventional static criteria application, realizes emotion estimation and dynamic criteria adjustment by AI, enabling flexible and highly accurate reliability evaluation tailored to the user's psychological state and information flow risk, and technically improving misjudgment risk and the soundness of information flow. Application fields include SNS platforms, news distribution services, enterprise information sharing infrastructure, and information literacy support systems for educational institutions. Thus, the evaluation unit achieves an improvement in computer technology by enabling AI-based emotion estimation and criteria adjustment, and can automatically perform reliability evaluation optimized for each user.

The evaluation unit can refer to the past reliability history of the information source to improve the accuracy of evaluation when evaluating the reliability of information. For example, the evaluation unit refers to the past reliability history of the information source to improve the accuracy of evaluation when evaluating the reliability of information. The evaluation unit can use generative AI to analyze the past reliability history of the information source. For example, the evaluation unit inputs the past reliability history of the information source to the generative AI, which then improves the accuracy of evaluation. The evaluation unit can refer to the past reliability scores of the information source and improve the accuracy of evaluation based on those scores. For example, the evaluation unit refers to the past reliability scores of the information source and preferentially evaluates information from highly reliable sources. The evaluation unit can also analyze the past reliability history of the information source and improve the accuracy of evaluation based on that history. For example, the evaluation unit analyzes the past reliability history of the information source and filters information from sources with low reliability. Thus, by referring to the past reliability history of the information source when evaluating the reliability of information, the evaluation unit can improve the accuracy of evaluation. Specifically, the evaluation unit receives identifiers of information sources (e.g., URL, media name, publisher ID) as input and matches them against a reliability history database. The reliability history database stores structured data such as past fact-check results, error rates, third-party certification status, past reliability scores (e.g., continuous value from 0.12 to 0.98), and evaluation labels (e.g., high, medium, low). The AI model extracts the relevant past reliability score series (e.g., array of scores for the past 10 cases) and time series data of evaluation labels from the history database for the input information source ID, and performs trend analysis using a time series analysis network based on LSTM or Transformer. Input examples include “Information source ID: media_123”, “Past scores: 0.95, 0.92, 0.90”, “Error rate: 0.01”, “Third-party certification: yes”, etc. The AI model outputs weighting to be reflected in the current reliability evaluation, priority for highly reliable sources, filtering threshold for low reliability sources, etc. Output examples include “Evaluation weight: 1.2 (high reliability)”, “Filtering: applied (low reliability)”, etc. These outputs are linked to subsequent processing such as reliability score calculation, warning generation, and supplementary information presentation. The AI model can be trained using supervised learning with paired data of past reliability history and evaluation results, or anomaly detection for extracting error trends. As a technical effect, the evaluation unit, unlike conventional one-off information evaluation, combines history reference and time series trend analysis by AI, thereby technically improving evaluation accuracy and misjudgment suppression. Application fields include SNS platforms, news distribution services, enterprise information sharing infrastructure, and information literacy support systems for educational institutions. Thus, the evaluation unit achieves an improvement in computer technology by enabling AI-based history analysis and accuracy improvement, and can automatically realize highly reliable information flow.

The evaluation unit can apply different evaluation algorithms for each category of information when evaluating the reliability of information. For example, the evaluation unit applies different evaluation algorithms for each category of information when evaluating the reliability of information. The evaluation unit can use generative AI to apply different evaluation algorithms for each category of information. For example, the evaluation unit inputs the category of information to the generative AI, which then applies different evaluation algorithms for each category. The evaluation unit can apply different evaluation algorithms for each news category and improve the accuracy of evaluation based on those algorithms. For example, the evaluation unit applies different evaluation algorithms for each news category and preferentially evaluates information from highly reliable sources. The evaluation unit can also apply different evaluation algorithms for each category of information and improve the accuracy of evaluation based on those algorithms. For example, the evaluation unit applies different evaluation algorithms for each category of information and filters information from sources with low reliability. Thus, by applying different evaluation algorithms for each category of information when evaluating the reliability of information, the evaluation unit can improve the accuracy of evaluation. Specifically, the evaluation unit automatically determines the category label of user post data (e.g., politics, economy, sports, technology, entertainment) using an automatic classifier (e.g., BERT-series text classification model or image classification CNN), and inputs the category label to an evaluation algorithm selection module. The AI model automatically selects the optimal evaluation algorithm for each category (e.g., fact-checking emphasis for politics, emphasis on timeliness and cross-referencing multiple sources for sports, emphasis on expert certification and patent database reference for technology), and dynamically switches parameters for reliability score calculation and warning generation. Input examples include “Category: politics”, “Post content: election result bulletin”, “Evaluation algorithm: fact-checking+error rate reference”, etc. The AI model outputs weighting of evaluation items for each category, priority for information sources, filtering threshold, etc. Output examples include “Evaluation algorithm: sports bulletin (cross-referencing multiple sources)”, “Evaluation algorithm: technology expert certification emphasis”, etc. These outputs are linked to subsequent processing such as reliability score calculation, warning generation, and supplementary information presentation. The AI model can be trained using supervised learning with paired data of category-specific evaluation results and algorithm selection history, or category clustering for automatic algorithm optimization. As a technical effect, the evaluation unit, unlike conventional uniform evaluation methods, realizes category-specific algorithm selection and dynamic evaluation by AI, enabling highly accurate reliability evaluation tailored to the characteristics of each information type, and technically improving misjudgment risk and the soundness of information flow. Application fields include SNS platforms, news distribution services, enterprise information sharing infrastructure, and information literacy support systems for educational institutions. Thus, the evaluation unit achieves an improvement in computer technology by enabling AI-based category-specific evaluation algorithm application, and can automatically perform reliability evaluation optimized for each information category.

The evaluation unit can estimate the user's emotion and adjust the order in which the results of reliability evaluation are displayed based on the emotion. For example, the evaluation unit estimates the user's emotion and adjusts the order in which the results of reliability evaluation are displayed based on the estimated emotion. Emotion estimation is realized using an emotion engine or generative AI, such as a text generative AI (e.g., LLM) or multimodal generative AI, but is not limited to these examples. For instance, if the user is excited, the evaluation unit preferentially displays highly reliable information. If the user is calm, the evaluation unit displays the results of reliability evaluation in the normal order. If the user is anxious, the evaluation unit preferentially displays information that provides reassurance. Thus, by adjusting the order in which the results of reliability evaluation are displayed according to the user's emotion, the evaluation unit can provide optimal information to the user. Specifically, the evaluation unit inputs user post data, recent behavior history, and posting metadata (e.g., posting time, presence of emojis and exclamation marks, past emotion scores) to an emotion estimation module, which uses a BERT-series encoder or multimodal Transformer to output emotion labels (e.g., excited, calm, anxious) and emotion intensity scores (e.g., 0.12 to 0.98). The AI model inputs the emotion estimation result and reliability evaluation results (e.g., reliability score, label, information category, importance score) to a priority determination module, and controls the display so that highly reliable information (e.g., score 0.95 or higher) is displayed at the top when the emotion state is “excited”, normal score order when “calm”, and information that provides reassurance (e.g., public institution announcements, FAQs) at the top when “anxious”. Input examples include “Emotion label: excited”, “Reliability score: 0.97”, “Information category: social news”, etc. The AI model outputs display order (e.g., 1st: public institution announcement, 2nd: major news organization, 3rd: general news) and emphasis display method (e.g., color coding, icon attachment). Output examples include “Display order: 1st (high reliability)”, “Display order: 2nd (reassurance emphasis)”, etc. These outputs are linked to display control on the user interface and warning/supplementary information presentation. The AI model can be trained using supervised learning with paired data of emotion state, display order selection, and user response. As a technical effect, the evaluation unit, unlike conventional static display order control, realizes emotion estimation and dynamic display order adjustment by AI, enabling information presentation tailored to the user's psychological state and information importance, reducing information oversight and the risk of misinformation spread, and technically improving user experience. Application fields include SNS platforms, news distribution services, enterprise information sharing infrastructure, and information literacy support systems for educational institutions. Thus, the evaluation unit achieves an improvement in computer technology by enabling AI-based emotion estimation and display order adjustment, and can automatically provide optimal information presentation to users.

The evaluation unit can consider the geographic distribution of information when evaluating its reliability. For example, the evaluation unit considers the geographic distribution of information when evaluating its reliability. The evaluation unit can use generative AI to identify the geographic distribution of information and evaluate it based on that distribution. For example, the evaluation unit inputs the geographic distribution of information to the generative AI, which then evaluates it based on the distribution. The evaluation unit can evaluate the reliability of information based on its geographic distribution. For example, the evaluation unit preferentially evaluates information related to specific regions based on its geographic distribution. The evaluation unit can also improve the accuracy of evaluation by considering the geographic distribution of information. For example, the evaluation unit considers the geographic distribution of information and preferentially evaluates information from highly reliable sources. Thus, by considering the geographic distribution of information when evaluating its reliability, the evaluation unit can improve the accuracy of evaluation. Specifically, the evaluation unit receives geographic metadata associated with user post data or news article data (e.g., posting location information, article origin, related place tags, GPS coordinates, prefecture/city/town names) as input. The input data is processed in the preprocessing unit by geocoding (e.g., converting latitude and longitude to administrative divisions), vectorizing location information (e.g., one-hot vectorization by location category or feature extraction by geographic clustering), and input to an AI model for geographic distribution analysis. The AI model uses a Transformer-based multivariate classification network or a graph neural network (GNN) that considers geographic features to analyze distribution patterns of information origin, dissemination, and reference locations. Input examples include “Posting location: Shinjuku-ku, Tokyo”, “Article origin: Osaka Prefecture”, “Related place tag: Kansai region”, “GPS coordinates: 35.6895, 139.6917”, etc. The AI model outputs geographic relevance score (e.g., 0.12 to 0.98), priority evaluation label (e.g., high, medium, low), and recommended evaluation criteria (e.g., region match emphasis, nationwide reliability emphasis). Output examples include “Geographic relevance: 0.93”, “Priority evaluation: high”, “Recommended criteria: region match emphasis”, etc. The evaluation unit preferentially evaluates information related to specific regions based on the AI model's output, and weights reliability scores for geographically reliable sources (e.g., regional media, official municipal announcements). Furthermore, if the geographic distribution is wide, nationwide reliability evaluation criteria are applied, while for local information, region-specific evaluation algorithms are applied. The AI model can be trained using supervised learning with paired data of geographic distribution-tagged post data and reliability evaluation results, or geographic clustering for extracting regional characteristics. In subsequent processing, the geographic distribution evaluation result is linked to warning generation, supplementary information presentation, and display order determination. As a technical effect, the evaluation unit, unlike conventional uniform evaluation methods that do not consider geographic factors, realizes geographic distribution analysis and dynamic evaluation criteria application by AI, enabling highly accurate reliability evaluation tailored to regional characteristics, and technically improving the risk of region-specific misinformation spread and the soundness of information flow. Application fields include regional SNS, local news distribution services, municipal information sharing infrastructure, and disaster information transmission systems. Thus, the evaluation unit achieves an improvement in computer technology by enabling AI-based geographic distribution analysis and evaluation criteria optimization, and can automatically perform reliability evaluation according to geographic context.

The evaluation unit can refer to related literature or data to improve the accuracy of evaluation when evaluating the reliability of information. For example, the evaluation unit refers to related literature or data to improve the accuracy of evaluation when evaluating the reliability of information. The evaluation unit can use generative AI to refer to related literature or data. For example, the evaluation unit inputs related literature or data to the generative AI, which then improves the accuracy of evaluation. The evaluation unit can refer to related literature or data and improve the accuracy of evaluation based on the reference. For example, the evaluation unit refers to related literature or data and preferentially evaluates information from highly reliable sources. The evaluation unit can also analyze related literature or data and improve the accuracy of evaluation based on the analysis. For example, the evaluation unit analyzes related literature or data and filters information from sources with low reliability. Thus, by referring to related literature or data when evaluating the reliability of information, the evaluation unit can improve the accuracy of evaluation. Specifically, the evaluation unit receives structured data such as keywords, source URLs, reference list, DOI numbers, academic paper titles, and statistical dataset IDs related to user post data or news article data as input. The input data is processed in the preprocessing unit by normalization, tokenization, and feature extraction (e.g., contextual vectorization using a BERT-series encoder, vectorization of literature metadata), and input to an AI model for literature/data reference. The AI model uses a Transformer-based information retrieval network, literature summary generation model, or knowledge graph inference model to analyze semantic similarity and citation relationships between the input information and a pre-constructed literature/database (e.g., academic paper database, statistical data repository, reliability-evaluated source list). Input examples include “Keyword: novel coronavirus”, “Source URL: https://example.com/data/123”, “DOI: 10.1234/abcd.2023.001”, etc. The AI model outputs related literature score (e.g., 0.12 to 0.98), recommended reference list (e.g., title, author, publication year), summary text (e.g., summary of main research results), and reliability evaluation correction value. Output examples include “Related literature score: 0.95”, “Recommended literature: Smith et al., 2023”, “Summary: matches main research results”, etc. The evaluation unit preferentially evaluates information supported by highly reliable literature or data based on the AI model's output, and filters or displays warnings for information from sources with low reliability or unclear basis. The AI model can be trained using supervised learning with paired data of literature/data reference history and reliability evaluation results, or knowledge graph extension for relevance inference. In subsequent processing, the literature reference result is linked to warning generation, supplementary information presentation, and display order determination. As a technical effect, the evaluation unit, unlike conventional manual literature investigation or static source list referencing, realizes dynamic literature/data reference and semantic similarity analysis by AI, enabling high-precision reliability evaluation based on evidence, and technically improving the suppression of misinformation spread and the soundness of information flow. Application fields include news distribution services, academic information distribution infrastructure, enterprise knowledge management, and information literacy support for educational institutions. Thus, the evaluation unit achieves an improvement in computer technology by enabling AI-based literature/data reference and accuracy improvement, and can automatically perform evidence-based reliability evaluation.

The providing unit can estimate the user's emotion and adjust the method of expressing warnings or supplementary information based on the emotion. For example, the providing unit estimates the user's emotion and adjusts the method of expressing warnings or supplementary information according to the estimated emotion. Emotion estimation is realized by using an emotion estimation function, such as an emotion engine or generative AI. Generative AI may include text generation AI (e.g., LLM) or multimodal generative AI, but is not limited thereto. For example, when the user is excited, the providing unit provides warnings or supplementary information using a calm expression. When the user is calm, the providing unit can provide warnings or supplementary information using a normal expression. When the user feels anxious, the providing unit can provide warnings or supplementary information using an expression that gives a sense of reassurance. Thus, by adjusting the method of expressing warnings or supplementary information according to the user's emotion, the providing unit can provide more appropriate information. Specifically, the providing unit inputs user post data, recent activity history, and post metadata (e.g., post time, emoji, presence of exclamation marks, past emotion scores) into an emotion estimation module, which outputs emotion labels (e.g., excited, calm, anxious) and emotion intensity scores (e.g., 0.12-0.98) using a BERT-series encoder or multimodal Transformer. Examples of input include “Post text: ‘XX went bankrupt today’”, “Emoji: [symbol] ”, “Emotion intensity: 0.93 (excited)”, etc. The AI model inputs the emotion estimation result into a warning/supplementary information generation module, and automatically selects an expression method determination algorithm (e.g., calm expression template, normal expression template, reassurance emphasis template, etc.). For example, in the case of “excited”, a calm expression (e.g., “Please check.”) is generated; in the case of “calm”, a normal expression (e.g., “This information may have low reliability.”) is generated; in the case of “anxious”, a reassurance emphasis expression (e.g., “Please rest assured. Reliable information sources are referenced.”) is generated. Examples of output include “Warning message: calm expression”, “Supplementary information: reassurance emphasis expression”, etc. Based on the output of the AI model, the providing unit automatically switches the expression method on the user interface, realizing information presentation optimized for the user's psychological state. Supervised learning using paired data of emotion state, expression method selection, and user response is applied for training the AI model. As a subsequent process, the result of expression method adjustment is also linked to warning display, supplementary information presentation, and determination of display order. As a technical effect, unlike conventional static expression methods, the providing unit realizes emotion estimation by AI and dynamic adjustment of expression methods, thereby technically improving user experience, suppression of misinformation diffusion, and soundness of information distribution. Application fields include SNS platforms, news distribution services, enterprise information sharing infrastructure, information literacy support systems for educational institutions, etc. Thus, the providing unit realizes an improvement in computer technology by emotion estimation and expression method adjustment using AI, and can automatically provide optimal information to users.

The providing unit can adjust the level of detail of warnings or supplementary information based on the importance of the information when providing such warnings or supplementary information. For example, the providing unit adjusts the level of detail of provision based on the importance of the information when providing warnings or supplementary information. The providing unit can use generative AI to evaluate the importance of the information and adjust the level of detail of provision based on the evaluation. For example, the providing unit inputs the importance of the information into generative AI, which then adjusts the level of detail of provision. For highly important information, the providing unit can provide detailed warnings or supplementary information. For example, the providing unit provides detailed warning messages or supplementary information for highly important information. For less important information, the providing unit can provide concise warnings or supplementary information. For example, the providing unit provides concise warning messages or supplementary information for less important information. Thus, by adjusting the level of detail of provision based on the importance of the information, the providing unit can appropriately provide necessary information to the user. Specifically, the providing unit inputs multidimensional feature vectors such as importance score of information received from the evaluation unit (e.g., 0.12-0.98), information category, past diffusion performance, and social impact indicators into a detail adjustment module. This detail adjustment module uses Transformer-based regression or classification models to automatically determine the level of detail (e.g., detailed, standard, brief) of warnings or supplementary information according to the importance score. Examples of input include “Importance score: 0.95”, “Information category: social news”, “Diffusion performance: high”, etc. The AI model outputs detail labels (e.g., detailed, standard, brief), recommended output templates (e.g., with detailed explanation, main points only), and example output sentences (e.g., detailed warning text, concise supplementary information text) based on these inputs. Examples of output include “Detail: detailed”, “Warning message: with detailed explanation”, “Supplementary information: main points only”, etc. Based on the output of the AI model, the providing unit automatically switches the level of detail of warnings or supplementary information on the user interface, realizing information presentation optimized for user needs and information importance. Supervised learning using paired data of information importance, detail selection, and user response is applied for training the AI model. As a subsequent process, the result of detail adjustment is also linked to warning display, supplementary information presentation, and determination of display order. As a technical effect, unlike conventional uniform information presentation, the providing unit realizes importance evaluation by AI and dynamic detail adjustment, thereby technically improving user experience, reducing the risk of information overload or insufficiency, and improving the efficiency and accuracy of information distribution. Application fields include SNS platforms, news distribution services, enterprise information sharing infrastructure, information literacy support systems for educational institutions, etc. Thus, the providing unit realizes an improvement in computer technology by importance evaluation and detail adjustment using AI, and can automatically provide optimal information to users.

The providing unit can apply different providing algorithms according to the category of information when providing warnings or supplementary information. For example, the providing unit applies different providing algorithms according to the category of information when providing warnings or supplementary information. The providing unit can use generative AI to apply different providing algorithms according to the category of information. For example, the providing unit inputs the category of information into generative AI, which applies different providing algorithms for each category. The providing unit applies different providing algorithms for each news category and can improve the accuracy of provision based on those algorithms. For example, the providing unit applies different providing algorithms for each news category and preferentially provides information from highly reliable sources. The providing unit can also apply different providing algorithms for each information category and improve the accuracy of provision based on those algorithms. For example, the providing unit applies different providing algorithms for each information category and filters information from less reliable sources. Thus, by applying different providing algorithms according to the category of information when providing warnings or supplementary information, the providing unit can improve the accuracy of provision. Specifically, the providing unit inputs information category (e.g., politics, economy, sports, technology, entertainment, etc.), reliability score, and information content feature vector received from the evaluation unit into a providing algorithm selection module. This module automatically selects warning/supplementary information generation algorithms optimized for each category (e.g., fact-checking emphasis for politics, emphasis on timeliness and multi-source verification for sports, expert validation and patent database reference for technology, etc.), and dynamically switches output templates, information source priority, filtering thresholds, etc. Examples of input include “Category: politics”, “Reliability score: 0.92”, “Information content: election result bulletin”, etc. The AI model outputs providing algorithm labels for each category (e.g., fact-checking, multi-source verification, expert validation), recommended output templates, filtering criteria, etc. Examples of output include “Providing algorithm: sports bulletin (multi-source verification)”, “Providing algorithm: technology expert validation emphasis”, etc. Based on the output of the AI model, the providing unit automatically presents warnings or supplementary information optimized for each category on the user interface. Supervised learning using paired data of category-specific provision results and algorithm selection history, as well as automatic algorithm optimization by category clustering, are applied for training the AI model. As a subsequent process, the result of providing algorithm selection is also linked to warning display, supplementary information presentation, and determination of display order. As a technical effect, unlike conventional uniform information presentation, the providing unit realizes category-specific algorithm selection and dynamic information provision by AI, enabling highly accurate information provision tailored to the characteristics of each information type, and technically improving the risk of misinformation diffusion and the soundness of information distribution. Application fields include SNS platforms, news distribution services, enterprise information sharing infrastructure, information literacy support systems for educational institutions, etc. Thus, the providing unit realizes an improvement in computer technology by category-specific providing algorithm application using AI, and can automatically provide information optimized for each information category.

The providing unit can estimate the user's emotion and adjust the length of warnings or supplementary information based on the emotion. For example, the providing unit estimates the user's emotion and adjusts the length of warnings or supplementary information according to the estimated emotion. Emotion estimation is realized by using an emotion estimation function, such as an emotion engine or generative AI. Generative AI may include text generation AI (e.g., LLM) or multimodal generative AI, but is not limited thereto. For example, when the user is excited, the providing unit provides short and concise warnings or supplementary information. When the user is calm, the providing unit can provide detailed warnings or supplementary information. When the user feels anxious, the providing unit can provide warnings or supplementary information that give a sense of reassurance. Thus, by adjusting the length of warnings or supplementary information according to the user's emotion, the providing unit can provide more appropriate information. Specifically, the providing unit inputs user post data, recent activity history, and post metadata (e.g., post time, emoji, presence of exclamation marks, past emotion scores) into an emotion estimation module, which outputs emotion labels (e.g., excited, calm, anxious) and emotion intensity scores (e.g., 0.12-0.98) using a BERT-series encoder or multimodal Transformer. Examples of input include “Post text: ‘XX went bankrupt today’”, “Emoji: [symbol] ”, “Emotion intensity: 0.93 (excited)”, etc. The AI model inputs the emotion estimation result into a warning/supplementary information generation module, and automatically selects a length adjustment algorithm (e.g., key point extraction type, detailed explanation type, reassurance emphasis type, etc.). For example, in the case of “excited”, a short and concise message (e.g., “This information has low reliability.”) is generated; in the case of “calm”, a message with detailed explanation (e.g., “This information has been judged as incorrect by past fact-checks. Please refer to the details below.”) is generated; in the case of “anxious”, a reassurance emphasis message with moderate explanation (e.g., “Please rest assured. Reliable information sources are referenced.”) is generated. Examples of output include “Warning message: short sentence”, “Supplementary information: detailed explanation”, “Supplementary information: reassurance emphasis”, etc. Based on the output of the AI model, the providing unit automatically switches the length of warnings or supplementary information on the user interface, realizing information presentation optimized for the user's psychological state and information importance. Supervised learning using paired data of emotion state, information length selection, and user response is applied for training the AI model. As a subsequent process, the result of length adjustment is also linked to warning display, supplementary information presentation, and determination of display order. As a technical effect, unlike conventional uniform information length presentation, the providing unit realizes emotion estimation by AI and dynamic adjustment of information length, thereby technically improving user experience, reducing the risk of information overload or insufficiency, and improving the efficiency and accuracy of information distribution. Application fields include SNS platforms, news distribution services, enterprise information sharing infrastructure, information literacy support systems for educational institutions, etc. Thus, the providing unit realizes an improvement in computer technology by emotion estimation and information length adjustment using AI, and can automatically provide optimal information to users.

The providing unit can determine the priority of provision based on the submission timing of information when providing warnings or supplementary information. For example, the providing unit determines the priority of provision based on the submission timing of information when providing warnings or supplementary information. The providing unit can use generative AI to identify the submission timing of information and determine the priority of provision based on that timing. For example, the providing unit inputs the submission timing of information into generative AI, which determines the priority of provision. For the latest information, the providing unit can preferentially provide warnings or supplementary information. For example, the providing unit provides warning messages or supplementary information preferentially for the latest information. For older information, the providing unit can lower the priority of provision. For example, the providing unit lowers the priority of provision for older information. Thus, by determining the priority of provision based on the submission timing of information, the providing unit can preferentially provide the latest information. Specifically, the providing unit inputs structured data such as submission time of information received from the evaluation unit (e.g., timestamp, post date, article publication date), information category, reliability score, etc., into a priority determination module. This module uses a time-series analysis AI model (e.g., LSTM, Transformer-based time-series classifier) to calculate novelty and freshness indicators (e.g., difference from current time, comparison with past diffusion performance), and automatically determines priority labels (e.g., high, medium, low), display order, and timing of warning/supplementary information presentation. Examples of input include “Submission time: 2024-06-01 12:00”, “Information category: economy”, “Reliability score: 0.92”, etc. The AI model outputs priority (e.g., latest information prioritized), recommended display timing (e.g., immediate, delayed, hidden), and output templates (e.g., for breaking news, for normal use, etc.) based on these inputs. Examples of output include “Priority: high (latest information)”, “Display timing: immediate”, “Warning message: for breaking news”, etc. Based on the output of the AI model, the providing unit preferentially presents the latest information as warnings or supplementary information on the user interface, and lowers the priority or hides older information. Supervised learning using paired data of information submission timing, priority selection, and user response, as well as time-series clustering for information freshness optimization, are applied for training the AI model. As a subsequent process, the result of priority determination is also linked to warning display, supplementary information presentation, and determination of display order. As a technical effect, unlike conventional static information presentation, the providing unit realizes submission timing analysis and dynamic priority determination by AI, enabling highly accurate information provision according to information freshness, and technically improving the efficiency and accuracy of information distribution while reducing the risk of information oversight and misinformation diffusion. Application fields include SNS platforms, news distribution services, enterprise information sharing infrastructure, information literacy support systems for educational institutions, etc. Thus, the providing unit realizes an improvement in computer technology by submission timing analysis and priority determination using AI, and can automatically provide optimal information to users.

The providing unit can adjust the order of provision based on the relevance of information when providing warnings or supplementary information. For example, the providing unit adjusts the order of provision based on the relevance of information when providing warnings or supplementary information. The providing unit can use generative AI to evaluate the relevance of information and adjust the order of provision based on the evaluation. For example, the providing unit inputs the relevance of information into generative AI, which adjusts the order of provision. For highly relevant information, the providing unit can preferentially provide warnings or supplementary information. For example, the providing unit provides warning messages or supplementary information preferentially for highly relevant information. For less relevant information, the providing unit can postpone the order of provision. For example, the providing unit postpones the order of provision for less relevant information. Thus, by adjusting the order of provision based on the relevance of information, the providing unit can preferentially provide important information to the user. Specifically, the providing unit inputs multidimensional data such as relevance score of information received from the evaluation unit (e.g., 0.12-0.98), user's field of interest, post content feature vector, and past browsing/posting history into a relevance evaluation module. This module uses Transformer-based multivariate regression or clustering models to calculate semantic similarity and relevance between information and the user's interests/behavior history, and automatically determines provision order labels (e.g., high, medium, low), display order, and timing of warning/supplementary information presentation. Examples of input include “Relevance score: 0.95”, “Field of interest: technology”, “Post content: AI technology”, etc. The AI model outputs provision order (e.g., highly relevant information prioritized), recommended display timing (e.g., immediate, delayed, hidden), and output templates (e.g., for emphasizing related information, for normal use, etc.) based on these inputs. Examples of output include “Provision order: 1st (high relevance)”, “Display timing: immediate”, “Warning message: related information emphasis”, etc. Based on the output of the AI model, the providing unit preferentially presents highly relevant information as warnings or supplementary information on the user interface, and postpones or hides less relevant information. Supervised learning using paired data of information relevance, provision order selection, and user response, as well as relevance clustering for information optimization, are applied for training the AI model. As a subsequent process, the result of provision order determination is also linked to warning display, supplementary information presentation, and determination of display order. As a technical effect, unlike conventional static information presentation, the providing unit realizes relevance evaluation and dynamic adjustment of provision order by AI, enabling highly accurate information provision tailored to the user's interests, and technically improving the efficiency and accuracy of information distribution while reducing the risk of information oversight and misinformation diffusion. Application fields include SNS platforms, news distribution services, enterprise information sharing infrastructure, information literacy support systems for educational institutions, etc. Thus, the providing unit realizes an improvement in computer technology by relevance evaluation and provision order adjustment using AI, and can automatically provide optimal information to users.

The reliability evaluation unit can estimate the user's emotion and adjust the criteria for evaluating the reliability of news sources based on the emotion. For example, the reliability evaluation unit estimates the user's emotion and adjusts the criteria for evaluating the reliability of news sources according to the estimated emotion. Emotion estimation is realized by using an emotion estimation function, such as an emotion engine or generative AI. Generative AI may include text generation AI (e.g., LLM) or multimodal generative AI, but is not limited thereto. For example, when the user is excited, the reliability evaluation unit applies strict reliability evaluation criteria. When the user is calm, the reliability evaluation unit can apply normal reliability evaluation criteria. When the user feels anxious, the reliability evaluation unit can apply reliability evaluation criteria that give a sense of reassurance. Thus, by adjusting the reliability evaluation criteria according to the user's emotion, the reliability evaluation unit can perform more appropriate reliability evaluation. Specifically, the reliability evaluation unit inputs user post data (e.g., text, images, videos, links, etc.) and post metadata (e.g., post time, emoji, presence of exclamation marks, past emotion scores) into an emotion estimation module. This emotion estimation module uses a BERT-series encoder or multimodal Transformer to output emotion labels (e.g., excited, calm, anxious) and emotion intensity scores (e.g., 0.12-0.98) from the input data. Examples of input include “Post text: ‘XX went bankrupt today’”, “Emoji: [symbol] ”, “Emotion intensity: 0.93 (excited)”, etc. The reliability evaluation unit inputs the emotion estimation result into a reliability evaluation criteria adjustment module, and, for example, in the case of “excited”, raises the fact-checking threshold to 0.95 and applies additional strict evaluation items such as past misinformation rate of the information source and presence of third-party certification. In the case of “calm”, normal thresholds (e.g., 0.85) and standard evaluation items are applied, and in the case of “anxious”, reliable sources such as public institutions and FAQs are preferentially referenced to give a sense of reassurance. Examples of AI model output include “Applied evaluation criteria: strict (threshold 0.95, reference to misinformation rate)”, “Applied evaluation criteria: standard (threshold 0.85)”, “Applied evaluation criteria: reassurance emphasis (public institution priority)”, etc. These criteria adjustments are also linked to subsequent processes such as reliability score calculation, warning generation, and supplementary information presentation. Supervised learning using paired data of emotion state, criteria selection, and evaluation results is applied for training the AI model. As a technical effect, unlike conventional static application of evaluation criteria, the reliability evaluation unit realizes emotion estimation by AI and dynamic adjustment of evaluation criteria, enabling flexible and highly accurate reliability evaluation tailored to the user's psychological state and information distribution risk, and technically improving the risk of misjudgment and the soundness of information distribution. Application fields include SNS platforms, news distribution services, enterprise information sharing infrastructure, information literacy support systems for educational institutions, etc. Thus, the reliability evaluation unit realizes an improvement in computer technology by emotion estimation and criteria adjustment using AI, and can automatically perform reliability evaluation optimized for each user.

The reliability evaluation unit can refer to past evaluation data to improve the accuracy of evaluation when evaluating the reliability of news sources. For example, the reliability evaluation unit refers to past evaluation data to improve the accuracy of evaluation when evaluating the reliability of news sources. The reliability evaluation unit can use generative AI to refer to past evaluation data. For example, the reliability evaluation unit inputs past evaluation data into generative AI, which improves the accuracy of evaluation. The reliability evaluation unit can refer to past reliability scores of news sources and improve the accuracy of evaluation based on those scores. For example, the reliability evaluation unit refers to past reliability scores of news sources and preferentially evaluates information from highly reliable news sources. The reliability evaluation unit can also analyze the past reliability history of news sources and improve the accuracy of evaluation based on that history. For example, the reliability evaluation unit analyzes the past reliability history of news sources and filters information from less reliable news sources. Thus, by referring to past evaluation data when evaluating the reliability of news sources, the reliability evaluation unit can improve the accuracy of evaluation. Specifically, the reliability evaluation unit receives identifiers of news sources (e.g., URL, media name, publisher ID, etc.) as input and matches them with a reliability history database. The reliability history database stores structured data such as past fact-check results, misinformation rates, presence of third-party certification, past reliability scores (e.g., continuous values from 0.12-0.98), and evaluation labels (e.g., high, medium, low). The AI model extracts the relevant past reliability score series (e.g., array of past 10 scores) and time-series data of evaluation labels from the history database for the input information source ID, and performs trend analysis using LSTM or Transformer-based time-series analysis networks. Examples of input include “Information source ID: media_123”, “Past scores: 0.95, 0.92, 0.90”, “Misinformation rate: 0.01”, “Third-party certification: present”, etc. The AI model outputs weighting to be reflected in the current reliability evaluation, priority of highly reliable information sources, filtering thresholds for less reliable information sources, etc., based on these inputs. Examples of output include “Evaluation weight: 1.2 (high reliability)”, “Filtering: applied (low reliability)”, etc. These outputs are also linked to subsequent processes such as reliability score calculation, warning generation, and supplementary information presentation. Supervised learning using paired data of past reliability history and evaluation results, as well as anomaly detection for extracting misinformation trends, are applied for training the AI model. As a technical effect, unlike conventional one-off information evaluation, the reliability evaluation unit combines history reference and time-series trend analysis by AI, thereby technically improving evaluation accuracy and suppression of misjudgment. Application fields include SNS platforms, news distribution services, enterprise information sharing infrastructure, information literacy support systems for educational institutions, etc. Thus, the reliability evaluation unit realizes an improvement in computer technology by history analysis and evaluation accuracy improvement using AI, and can automatically realize the distribution of highly reliable information.

The reliability evaluation unit can apply different evaluation methods according to the category of information when evaluating the reliability of news sources. For example, the reliability evaluation unit applies different evaluation methods according to the category of information when evaluating the reliability of news sources. The reliability evaluation unit can use generative AI to apply different evaluation methods according to the category of information. For example, the reliability evaluation unit inputs the category of information into generative AI, which applies different evaluation methods for each category. The reliability evaluation unit applies different evaluation methods for each news category and can improve the accuracy of evaluation based on those methods. For example, the reliability evaluation unit applies different evaluation methods for each news category and preferentially evaluates information from highly reliable news sources. The reliability evaluation unit can also apply different evaluation methods for each information category and improve the accuracy of evaluation based on those methods. For example, the reliability evaluation unit applies different evaluation methods for each information category and filters information from less reliable news sources. Thus, by applying different evaluation methods according to the category of information when evaluating the reliability of news sources, the reliability evaluation unit can improve the accuracy of evaluation. Specifically, the reliability evaluation unit determines the category label of user post data (e.g., politics, economy, sports, technology, entertainment, etc.) using an automatic classifier (e.g., BERT-series text classification model or image classification CNN), and inputs the category label into an evaluation algorithm selection module. The AI model automatically selects evaluation algorithms optimized for each category (e.g., fact-checking emphasis for politics, emphasis on timeliness and multi-source verification for sports, expert validation and patent database reference for technology, etc.), and dynamically switches parameters for reliability score calculation and warning generation. Examples of input include “Category: politics”, “Post content: election result bulletin”, “Evaluation algorithm: fact-checking+reference to misinformation rate”, etc. The AI model outputs weighting of evaluation items for each category, information source priority, filtering thresholds, etc. Examples of output include “Evaluation algorithm: sports bulletin (multi-source verification)”, “Evaluation algorithm: technology expert validation emphasis”, etc. These outputs are also linked to subsequent processes such as reliability score calculation, warning generation, and supplementary information presentation. Supervised learning using paired data of category-specific evaluation results and algorithm selection history, as well as automatic algorithm optimization by category clustering, are applied for training the AI model. As a technical effect, unlike conventional uniform evaluation methods, the reliability evaluation unit realizes category-specific algorithm selection and dynamic evaluation by AI, enabling highly accurate reliability evaluation tailored to the characteristics of each information type, and technically improving the risk of misjudgment and the soundness of information distribution. Application fields include SNS platforms, news distribution services, enterprise information sharing infrastructure, information literacy support systems for educational institutions, etc. Thus, the reliability evaluation unit realizes an improvement in computer technology by category-specific evaluation algorithm application using AI, and can automatically perform reliability evaluation optimized for each information category.

The reliability evaluation unit can estimate the user's emotion and adjust the order of displaying reliability evaluation results based on the emotion. For example, the reliability evaluation unit estimates the user's emotion and adjusts the order of displaying reliability evaluation results according to the estimated emotion. Emotion estimation is realized by using an emotion estimation function, such as an emotion engine or generative AI. Generative AI may include text generation AI (e.g., LLM) or multimodal generative AI, but is not limited thereto. For example, when the user is excited, the reliability evaluation unit preferentially displays highly reliable information. When the user is calm, the reliability evaluation unit can display reliability evaluation results in the normal order. When the user feels anxious, the reliability evaluation unit can preferentially display information that gives a sense of reassurance. Thus, by adjusting the order of displaying reliability evaluation results according to the user's emotion, the reliability evaluation unit can provide optimal information to the user. Specifically, the reliability evaluation unit inputs user post data, recent activity history, and post metadata (e.g., post time, emoji, presence of exclamation marks, past emotion scores) into an emotion estimation module, which outputs emotion labels (e.g., excited, calm, anxious) and emotion intensity scores (e.g., 0.12-0.98) using a BERT-series encoder or multimodal Transformer. The AI model inputs the emotion estimation result and reliability evaluation results (e.g., reliability score, label, information category, importance score, etc.) into a priority determination module, and, for example, when the emotion state is “excited”, displays information with high reliability scores (e.g., score 0.95 or higher) at the top; when “calm”, displays in normal score order; when “anxious”, displays information that gives a sense of reassurance (e.g., public institution announcements, FAQs, etc.) at the top. Examples of input include “Emotion label: excited”, “Reliability score: 0.97”, “Information category: social news”, etc. The AI model outputs display order (e.g., 1st: public institution announcement, 2nd: major news agency, 3rd: general news) and emphasis display methods (e.g., color coding, icon attachment). Examples of output include “Display order: 1st (high reliability)”, “Display order: 2nd (reassurance emphasis)”, etc. These outputs are also linked to display control on the user interface and warning/supplementary information presentation. Supervised learning using paired data of emotion state, display order selection, and user response is applied for training the AI model. As a technical effect, unlike conventional static display order control, the reliability evaluation unit realizes emotion estimation by AI and dynamic adjustment of display order, enabling information presentation tailored to the user's psychological state and information importance, and technically improving the risk of information oversight and misinformation diffusion while enhancing user experience. Application fields include SNS platforms, news distribution services, enterprise information sharing infrastructure, information literacy support systems for educational institutions, etc. Thus, the reliability evaluation unit realizes an improvement in computer technology by emotion estimation and display order adjustment using AI, and can automatically provide optimal information presentation to users.

The reliability evaluation unit can consider the geographic distribution of information when evaluating the reliability of news sources. For example, the reliability evaluation unit considers the geographic distribution of information when evaluating the reliability of news sources. The reliability evaluation unit can use generative AI to identify the geographic distribution of information and evaluate based on that distribution. For example, the reliability evaluation unit inputs the geographic distribution of information into generative AI, which evaluates based on the distribution. The reliability evaluation unit can evaluate reliability based on the geographic distribution of information. For example, the reliability evaluation unit preferentially evaluates information related to specific regions based on the geographic distribution of information. The reliability evaluation unit can also improve the accuracy of evaluation by considering the geographic distribution of information. For example, the reliability evaluation unit considers the geographic distribution of information and preferentially evaluates information from highly reliable news sources. Thus, by considering the geographic distribution of information when evaluating the reliability of news sources, the reliability evaluation unit can improve the accuracy of evaluation. Specifically, the reliability evaluation unit receives geographic metadata associated with news article data or user post data (e.g., post location information, article origin, related place tags, GPS coordinates, prefecture/city names, etc.) as input. The input data is preprocessed by geocoding (e.g., latitude/longitude to administrative area conversion), vectorization of location information (e.g., one-hot vectorization by location category or feature extraction by geographic clustering), and then input into a geographic distribution analysis AI model. This AI model uses Transformer-based multivariate classification networks or graph neural networks (GNN) that consider geographic features to analyze distribution patterns of information origin, diffusion, and reference locations. Examples of input include “Post location: Shinjuku-ku, Tokyo”, “Article origin: Osaka Prefecture”, “Related place tag: Kansai region”, “GPS coordinates: 35.6895, 139.6917”, etc. The AI model outputs geographic relevance scores (e.g., 0.12-0.98), priority evaluation labels (e.g., high, medium, low), and recommended evaluation criteria (e.g., emphasis on regional consistency, emphasis on nationwide reliability) based on these inputs. Examples of output include “Geographic relevance: 0.93”, “Priority evaluation: high”, “Recommended criteria: emphasis on regional consistency”, etc. Based on the output of the AI model, the reliability evaluation unit preferentially evaluates information related to specific regions and calculates reliability scores by weighting geographically reliable news sources (e.g., local media, official municipal announcements). Furthermore, when the geographic distribution is wide, nationwide reliability evaluation criteria are applied, and for local information, region-specific evaluation algorithms are applied. Supervised learning using paired data of posts with geographic distribution and reliability evaluation results, as well as geographic clustering for regional feature extraction, are applied for training the AI model. As a subsequent process, the result of geographic distribution evaluation is also linked to warning generation, supplementary information presentation, and determination of display order. As a technical effect, unlike conventional uniform evaluation methods that do not consider geographic factors, the reliability evaluation unit realizes geographic distribution analysis and dynamic application of evaluation criteria by AI, enabling highly accurate reliability evaluation tailored to regional characteristics, and technically improving the risk of region-specific misinformation diffusion and the soundness of information distribution. Application fields include regional SNS, local news distribution services, municipal information sharing infrastructure, disaster information transmission systems, etc. Thus, the reliability evaluation unit realizes an improvement in computer technology by geographic distribution analysis and evaluation criteria optimization using AI, and can automatically perform reliability evaluation according to geographic context.

The reliability evaluation unit can refer to related literature or data to improve the accuracy of evaluation when evaluating the reliability of news sources. For example, the reliability evaluation unit refers to related literature or data to improve the accuracy of evaluation when evaluating the reliability of news sources. The reliability evaluation unit can use generative AI to refer to related literature or data. For example, the reliability evaluation unit inputs related literature or data into generative AI, which improves the accuracy of evaluation. The reliability evaluation unit can refer to related literature or data and improve the accuracy of evaluation based on the reference. For example, the reliability evaluation unit refers to related literature or data and preferentially evaluates information from highly reliable news sources. The reliability evaluation unit can also analyze related literature or data and improve the accuracy of evaluation based on the analysis. For example, the reliability evaluation unit analyzes related literature or data and filters information from less reliable news sources. Thus, by referring to related literature or data when evaluating the reliability of news sources, the reliability evaluation unit can improve the accuracy of evaluation. Specifically, the reliability evaluation unit receives structured data such as keywords related to news article data or post data, source URLs, citation lists, DOI numbers, academic paper titles, statistical dataset IDs, etc., as input. The input data is preprocessed by normalization, tokenization, and feature extraction (e.g., contextual vectorization by BERT-series encoder, vectorization of literature metadata), and then input into a literature/data reference AI model. This AI model uses Transformer-based information retrieval networks, literature summary generation models, knowledge graph inference models, etc., to analyze semantic similarity and citation relationships between input information and pre-constructed literature/databases (e.g., academic paper databases, statistical data repositories, lists of sources with reliability evaluation, etc.). Examples of input include “Keyword: novel coronavirus”, “Source URL: https://example.com/data/123”, “DOI: 10.1234/abcd.2023.001”, etc. The AI model outputs related literature scores (e.g., 0.12-0.98), recommended reference literature lists (e.g., title, author, publication year), summary texts (e.g., summary of main research results), reliability evaluation correction values, etc., based on these inputs. Examples of output include “Related literature score: 0.95”, “Recommended literature: Smith et al., 2023”, “Summary: matches main research results”, etc. Based on the output of the AI model, the reliability evaluation unit preferentially evaluates information supported by highly reliable literature or data, and filters or displays warnings for information from less reliable news sources or information with unclear sources. Supervised learning using paired data of literature/data reference history and reliability evaluation results, as well as knowledge graph extension for relevance inference, are applied for training the AI model. As a subsequent process, the result of literature reference is also linked to warning generation, supplementary information presentation, and determination of display order. As a technical effect, unlike conventional manual literature research or static reference list consultation, the reliability evaluation unit realizes dynamic literature/data reference and semantic similarity analysis by AI, enabling highly accurate reliability evaluation based on evidence, and technically improving the suppression of misinformation diffusion and the soundness of information distribution. Application fields include news distribution services, academic information distribution infrastructure, enterprise knowledge management, information literacy support for educational institutions, etc. Thus, the reliability evaluation unit realizes an improvement in computer technology by literature/data reference and evaluation accuracy improvement using AI, and can automatically perform reliability evaluation based on evidence.

The display unit can estimate the user's emotion and adjust the display method based on the emotion. For example, the display unit estimates the user's emotion and adjusts the display method according to the estimated emotion. Emotion estimation is realized by using an emotion estimation function, such as an emotion engine or generative AI. Generative AI may include text generation AI (e.g., LLM) or multimodal generative AI, but is not limited thereto. For example, when the user is excited, the display unit provides a simple and highly visible display method. When the user is calm, the display unit can provide a display method including detailed information. When the user feels anxious, the display unit can provide a display method that gives a sense of reassurance. Thus, by adjusting the display method according to the user's emotion, the display unit can provide more appropriate information. Specifically, the display unit inputs user post data (e.g., text, images, videos, links, etc.), recent activity history, and post metadata (e.g., post time, emoji, presence of exclamation marks, past emotion scores) into an emotion estimation module. This emotion estimation module uses a BERT-series encoder or multimodal Transformer to output emotion labels (e.g., excited, calm, anxious) and emotion intensity scores (e.g., 0.12-0.98) from the input data. Examples of input include “Post text: ‘XX went bankrupt today’”, “Emoji: [symbol] ”, “Emotion intensity: 0.93 (excited)”, etc. The AI model inputs the emotion estimation result into a display method determination module, and automatically selects display templates (e.g., simple display, detailed display, reassurance emphasis display) and layout parameters (e.g., font size, color, emphasis degree). For example, in the case of “excited”, a simple card-type display with limited information and color emphasis on important information is applied; in the case of “calm”, a rich display with detailed explanation and related information links is generated; in the case of “anxious”, a display with reassuring colors (e.g., blue tones), supplementary explanations, and FAQ links is generated. Examples of output include “Display template: simple”, “Emphasis color: red”, “Supplementary information: reassurance emphasis”, etc. Based on the output of the AI model, the display unit automatically switches the display method on the user interface, realizing information presentation optimized for the user's psychological state and information importance. Supervised learning using paired data of emotion state, display method selection, and user response is applied for training the AI model. As a subsequent process, the result of display method adjustment is also linked to warning display, supplementary information presentation, and determination of display order. As a technical effect, unlike conventional static display methods, the display unit realizes emotion estimation by AI and dynamic adjustment of display methods, thereby technically improving user experience, suppression of misinformation diffusion, and soundness of information distribution. Application fields include SNS platforms, news distribution services, enterprise information sharing infrastructure, information literacy support systems for educational institutions, etc. Thus, the display unit realizes an improvement in computer technology by emotion estimation and display method adjustment using AI, and can automatically provide optimal information presentation to users.

The display unit can select the optimal display method by referring to the user's past operation history at the time of display. For example, the display unit selects the optimal display method by referring to the user's past operation history at the time of display. The display unit can use generative AI to analyze the user's past operation history. For example, the display unit inputs the user's past operation history into generative AI, which selects the optimal display method. The display unit can propose the optimal display method based on the display methods previously selected by the user. For example, the display unit proposes the optimal display method based on the display methods previously selected by the user. The display unit can also select the optimal display method by analyzing the user's past operation history. For example, the display unit analyzes the user's past operation history and selects the optimal display method. Thus, by referring to the user's past operation history, the display unit can select the optimal display method. Specifically, the display unit inputs multidimensional operation logs such as the user's past display setting change history, display template selection history, screen layout changes, font size adjustments, color theme selections, information detail level selections, viewing time, click positions, scroll amounts, etc., into an operation history analysis module. This module uses time-series models (e.g., LSTM, Transformer) and clustering algorithms to extract display preference patterns and operation tendencies for each user. Examples of input include “Past display templates: simple 10 times, detailed 5 times”, “Font size change: large 2 times”, “Color theme: dark mode 8 times”, etc. The AI model outputs optimal display method labels (e.g., simple, detailed, dark mode), recommended layout parameters (e.g., font size 16 px, card-type display), and display detail level (e.g., main points only, with detailed explanation), etc., based on these inputs. Examples of output include “Recommended display method: simple”, “Recommended font size: 16 px”, “Recommended color theme: dark”, etc. Based on the output of the AI model, the display unit automatically applies the optimal display method on the user interface, realizing information presentation tailored to the user's past operation history. Supervised learning using paired data of operation history, display method selection, and user satisfaction, as well as clustering for preference group extraction, are applied for training the AI model. As a subsequent process, the result of display method selection is also linked to warning display, supplementary information presentation, and determination of display order. As a technical effect, unlike conventional static display settings, the display unit realizes operation history analysis and dynamic optimization of display methods by AI, thereby technically improving user experience, personalization of information presentation, and the efficiency and accuracy of information distribution. Application fields include SNS platforms, news distribution services, enterprise information sharing infrastructure, information literacy support systems for educational institutions, etc. Thus, the display unit realizes an improvement in computer technology by operation history analysis and display method optimization using AI, and can automatically provide information presentation optimized for each user.

The display unit can apply different display algorithms according to the category of information at the time of display. For example, the display unit applies different display algorithms according to the category of information at the time of display. The display unit can use generative AI to apply different display algorithms according to the category of information. For example, the display unit inputs the category of information into generative AI, which applies different display algorithms for each category. The display unit applies different display algorithms for each news category and can improve the accuracy of display based on those algorithms. For example, the display unit applies different display algorithms for each news category and preferentially displays information from highly reliable sources. The display unit can also apply different display algorithms for each information category and improve the accuracy of display based on those algorithms. For example, the display unit applies different display algorithms for each information category and filters information from less reliable sources. Thus, by applying different display algorithms according to the category of information at the time of display, the display unit can improve the accuracy of display. Specifically, the display unit inputs information category (e.g., politics, economy, sports, technology, entertainment, etc.), reliability score, and information content feature vector received from the evaluation unit or reliability evaluation unit into a display algorithm selection module. This module automatically selects display algorithms optimized for each category (e.g., fact-checking emphasis display for politics, emphasis on timeliness and timeline for sports, addition of expert comments and patent database links for technology, etc.), and dynamically switches layout, emphasis display, information source priority, filtering thresholds, etc. Examples of input include “Category: politics”, “Reliability score: 0.92”, “Information content: election result bulletin”, etc. The AI model outputs display algorithm labels for each category (e.g., fact-checking, timeline, expert-comment), recommended layout, emphasis display methods, etc., based on these inputs. Examples of output include “Display algorithm: sports bulletin (timeline emphasis)”, “Display algorithm: technology expert comment addition”, etc. Based on the output of the AI model, the display unit automatically presents information optimized for each category on the user interface. Supervised learning using paired data of category-specific display results and algorithm selection history, as well as automatic algorithm optimization by category clustering, are applied for training the AI model. As a subsequent process, the result of display algorithm selection is also linked to warning display, supplementary information presentation, and determination of display order. As a technical effect, unlike conventional uniform information presentation, the display unit realizes category-specific algorithm selection and dynamic information display by AI, enabling highly accurate information presentation tailored to the characteristics of each information type, and technically improving the risk of misinformation diffusion and the soundness of information distribution. Application fields include SNS platforms, news distribution services, enterprise information sharing infrastructure, information literacy support systems for educational institutions, etc. Thus, the display unit realizes an improvement in computer technology by category-specific display algorithm application using AI, and can automatically provide information presentation optimized for each information category.

The display unit can estimate the user's emotion and determine the priority of display based on the emotion. For example, the display unit estimates the user's emotion and determines the priority of display according to the estimated emotion. Emotion estimation is realized by using an emotion estimation function, such as an emotion engine or generative AI. Generative AI may include text generation AI (e.g., LLM) or multimodal generative AI, but is not limited thereto. For example, when the user is excited, the display unit preferentially displays highly important information. When the user is calm, the display unit can display information in the normal priority order. When the user feels anxious, the display unit can preferentially display information that gives a sense of reassurance. Thus, by determining the priority of display according to the user's emotion, the display unit can preferentially display important information. Specifically, the display unit inputs user post data, recent activity history, and post metadata (e.g., post time, emoji, presence of exclamation marks, past emotion scores) into an emotion estimation module, which outputs emotion labels (e.g., excited, calm, anxious) and emotion intensity scores (e.g., 0.12-0.98) using a BERT-series encoder or multimodal Transformer. The AI model inputs the emotion estimation result and importance score of information (e.g., information category, reliability score, past diffusion performance, etc.) into a priority determination module, and, for example, when the emotion state is “excited”, displays highly important information (e.g., news with large social impact, highly urgent information) at the top; when “calm”, displays in normal priority order; when “anxious”, displays information that gives a sense of reassurance (e.g., public institution announcements, FAQs, etc.) at the top. Examples of input include “Emotion label: excited”, “Importance score: 0.97”, “Information category: social news”, etc. The AI model outputs display order (e.g., 1st: public institution announcement, 2nd: major news agency, 3rd: general news) and emphasis display methods (e.g., color coding, icon attachment). Examples of output include “Display order: 1st (high reliability)”, “Display order: 2nd (reassurance emphasis)”, etc. Based on the output of the AI model, the display unit automatically switches display order and emphasis display on the user interface, realizing information presentation optimized for the user's psychological state and information importance. Supervised learning using paired data of emotion state, display order selection, and user response is applied for training the AI model. As a subsequent process, the result of display order determination is also linked to warning display, supplementary information presentation, and determination of display order. As a technical effect, unlike conventional static display order control, the display unit realizes emotion estimation by AI and dynamic adjustment of display order, enabling information presentation tailored to the user's psychological state and information importance, and technically improving the risk of information oversight and misinformation diffusion while enhancing user experience. Application fields include SNS platforms, news distribution services, enterprise information sharing infrastructure, information literacy support systems for educational institutions, etc. Thus, the display unit realizes an improvement in computer technology by emotion estimation and display order adjustment using AI, and can automatically provide optimal information presentation to users.

The display unit can select the optimal display method by considering the user's device information at the time of display. For example, the display unit selects the optimal display method by considering the user's device information at the time of display. The display unit can use generative AI to identify the user's device information and adjust the display method based on that information. For example, the display unit inputs the user's device information into generative AI, which selects the optimal display method. When the user is using a smartphone, the display unit can provide a display method optimized for the screen size. For example, the display unit provides a display method optimized for the screen size of a smartphone. When the user is using a tablet, the display unit can also provide a display method optimized for the larger screen. For example, the display unit provides a display method optimized for the screen size of a tablet. When the user is using a smartwatch, the display unit can also provide a concise and highly visible display method. For example, the display unit provides a display method optimized for the screen size of a smartwatch. Thus, by considering the user's device information, the display unit can select the optimal display method. Specifically, the display unit inputs multidimensional device information obtained from the user terminal, such as device type (e.g., smartphone, tablet, smartwatch, notebook PC, desktop PC, etc.), screen resolution, screen size, OS version, input interface (touch, mouse, voice, etc.), application usage information, etc., into a device information analysis module. This module automatically selects display templates optimized for each device type (e.g., vertical card type for smartphones, grid type for tablets, concise display for smartwatches, detailed display for PCs, etc.) and layout parameters (e.g., font size, icon size, button arrangement). Examples of input include “Device type: smartphone”, “Screen resolution: 1080×2400”, “Input method: touch”, etc. The AI model outputs recommended display templates (e.g., mobile_card, tablet_grid, watch_brief), layout parameters (e.g., font size 14 px, large icons), information detail level (e.g., main points only, with detailed explanation), etc., based on these inputs. Examples of output include “Recommended display method: mobile_card”, “Recommended font size: 14 px”, “Recommended information detail level: brief”, etc. Based on the output of the AI model, the display unit automatically applies the display method optimized for each device on the user interface, realizing information presentation tailored to the user's usage environment. Supervised learning using paired data of device information, display method selection, and user satisfaction, as well as device clustering for optimization, are applied for training the AI model. As a subsequent process, the result of display method selection is also linked to warning display, supplementary information presentation, and determination of display order. As a technical effect, unlike conventional uniform display settings, the display unit realizes device information analysis and dynamic optimization of display methods by AI, thereby technically improving user experience, suitability of information presentation, and the efficiency and accuracy of information distribution. Application fields include SNS platforms, news distribution services, enterprise information sharing infrastructure, information literacy support systems for educational institutions, etc. Thus, the display unit realizes an improvement in computer technology by device information analysis and display method optimization using AI, and can automatically provide information presentation optimized for each user and device.

The display unit can adjust the order of display based on the relevance of information at the time of display. For example, the display unit adjusts the order of display based on the relevance of information at the time of display. The display unit can use generative AI to evaluate the relevance of information and adjust the order of display based on the evaluation. For example, the display unit inputs the relevance of information into generative AI, which adjusts the order of display. For highly relevant information, the display unit can preferentially display it. For example, the display unit preferentially displays highly relevant information. For less relevant information, the display unit can postpone the order of display. For example, the display unit postpones the order of display for less relevant information. Thus, by adjusting the order of display based on the relevance of information, the display unit can preferentially display important information to the user. Specifically, the display unit inputs multidimensional data such as relevance score of information received from the evaluation unit or reliability evaluation unit (e.g., 0.12-0.98), user's field of interest, post content feature vector, past browsing/posting history, etc., into a relevance evaluation module. This module uses Transformer-based multivariate regression or clustering models to calculate semantic similarity and relevance between information and the user's interests/behavior history, and automatically determines display order labels (e.g., high, medium, low), display order, and emphasis display methods (e.g., related information emphasis color, icon attachment). Examples of input include “Relevance score: 0.95”, “Field of interest: technology”, “Post content: AI technology”, etc. The AI model outputs display order (e.g., highly relevant information prioritized), recommended display timing (e.g., immediate, delayed, hidden), and output templates (e.g., for emphasizing related information, for normal use, etc.) based on these inputs. Examples of output include “Display order: 1st (high relevance)”, “Display timing: immediate”, “Emphasis display: related information emphasis”, etc. Based on the output of the AI model, the display unit preferentially displays highly relevant information on the user interface, and postpones or hides less relevant information. Supervised learning using paired data of information relevance, display order selection, and user response, as well as relevance clustering for information optimization, are applied for training the AI model. As a subsequent process, the result of display order determination is also linked to warning display, supplementary information presentation, and determination of display order. As a technical effect, unlike conventional static information presentation, the display unit realizes relevance evaluation and dynamic adjustment of display order by AI, enabling highly accurate information presentation tailored to the user's interests, and technically improving the efficiency and accuracy of information distribution while reducing the risk of information oversight and misinformation diffusion. Application fields include SNS platforms, news distribution services, enterprise information sharing infrastructure, information literacy support systems for educational institutions, etc. Thus, the display unit realizes an improvement in computer technology by relevance evaluation and display order adjustment using AI, and can automatically provide optimal information presentation to users.

The system according to the embodiment is not limited to the examples described above and can be variously modified as follows, for example. Specifically, the present system allows for diverse variations in the module configuration of the receiving unit, evaluation unit, providing unit, reliability evaluation unit, display unit, AI model architecture, data flow, learning methods, input/output specifications, and so on. For example, the receiving unit can add or extend types of input data such as user behavior data, geographic location information, social media activity, etc.; the evaluation unit can utilize multiple reliability evaluation algorithms and reference databases (e.g., literature, statistical data, knowledge graphs, etc.) in combination; the providing unit can customize warning/supplementary information generation algorithms and expression method templates; the reliability evaluation unit can improve evaluation accuracy by adding anomaly detection models or time-series analysis models; and the display unit can flexibly switch display methods, layouts, and emphasis displays according to device type, user attributes, and usage conditions. Various learning methods can be applied to the AI model, including supervised learning, semi-supervised learning, self-supervised learning, transfer learning, and reinforcement learning. Furthermore, as the linkage method between modules, sequential processing, parallel processing, batch processing, stream processing, etc., can be selected, and distributed execution in cloud environments or on edge devices is also allowed. Thus, the present system is not limited to specific configurations or algorithms and realizes a computer technology improvement story that can be flexibly expanded or modified according to technological evolution and operational requirements. Application fields include SNS platforms, news distribution services, enterprise information sharing infrastructure, information literacy support systems for educational institutions, disaster information transmission systems, academic information distribution infrastructure, etc.

The receiving unit can analyze the user's past posting history and preferentially receive information related to specific topics. For example, information related to topics that the user has frequently posted about in the past is preferentially received. The receiving unit can use generative AI to analyze the user's past posting history and select the optimal receiving method based on that history. For example, information containing keywords related to topics that the user has frequently posted about in the past is preferentially received. Thus, by analyzing the user's past posting history, the receiving unit can preferentially receive highly relevant information. Specifically, the receiving unit normalizes, tokenizes, and extracts features (e.g., contextual vectorization by BERT-series encoder, topic estimation by category classifier) from multidimensional history data such as the user's past post data (e.g., text, images, videos, links, etc.), post time, post category, post content keywords, posting frequency, and posting group, and inputs them into a posting history analysis AI model. This AI model uses time-series models (e.g., LSTM, Transformer) or clustering models to extract the user's posting tendencies and topics of interest. Examples of input include “Past posts: 10 technology articles”, “Posting frequency: 5 times per week”, “Post category: economy”, etc. The AI model outputs priority topic labels (e.g., technology, economy), relevance scores (e.g., 0.89), recommended keyword lists (e.g., AI, stock price, smartphone), etc., based on these inputs. Examples of output include “Priority topic: technology”, “Relevance: 0.92”, “Recommended keywords: AI, IoT, smartphone”, etc. Based on the output of the AI model, the receiving unit preferentially receives only information matching the priority topic at the time of post reception, and excludes or displays warnings for less relevant information from the reception candidates. Supervised learning using paired data of posting history and priority topic annotation, as well as clustering for automatic extraction of fields of interest, are applied for training the AI model. As a subsequent process, the result of posting history analysis is also linked to reliability evaluation of post content and warning generation. As a technical effect, unlike conventional static category selection or manual filtering, the receiving unit realizes dynamic posting history analysis and information reception filtering by AI, thereby promoting information distribution tailored to the user's interests and suppressing the inflow of noisy information, and technically improving information relevance and user experience. Application fields include SNS platforms, news distribution services, enterprise information sharing infrastructure, information literacy support systems for educational institutions, etc. Thus, the receiving unit realizes an improvement in computer technology by posting history analysis and information filtering using AI, and can automatically perform optimal information reception for users.

The evaluation unit can apply different evaluation criteria for each category of information when evaluating the reliability of information. For example, different evaluation criteria can be applied for each news category, thereby improving the accuracy of evaluation based on those criteria. The evaluation unit can use generative AI to apply different evaluation criteria for each category of information. For instance, the category of information is input to the generative AI, which then applies different evaluation criteria for each category. As a result, the evaluation unit can improve the accuracy of evaluation by applying different evaluation criteria for each category of information when evaluating reliability. Specifically, the evaluation unit automatically classifies user-posted data categories (e.g., politics, economy, sports, technology, entertainment, etc.) using automatic classifiers (e.g., BERT-based text classification models or image classification CNNs), and inputs the category label to an evaluation criteria selection module. The AI model automatically selects optimized evaluation criteria for each category (e.g., fact-checking emphasis for politics, emphasis on timeliness and cross-referencing multiple sources for sports, emphasis on expert authentication and patent database reference for technology, etc.), and dynamically switches parameters for reliability score calculation and warning generation. Examples of input include “Category: Politics”, “Post content: Election result breaking news”, “Evaluation criteria: Fact-checking+reference to misinformation rate”, etc. The AI model outputs category-specific evaluation item weights, information source priority, filtering thresholds, and so on. Examples of output include “Evaluation criteria: For sports breaking news (cross-referencing multiple sources)”, “Evaluation criteria: Technology expert authentication emphasis”, etc. These outputs are linked to subsequent processes such as reliability score calculation, warning generation, and supplementary information presentation. For training the AI model, supervised learning using paired data of category-specific evaluation results and criteria selection history, as well as automatic criteria optimization by category clustering, are applied. As a technical effect, the evaluation unit, unlike conventional uniform evaluation methods, realizes category-specific criteria selection and dynamic evaluation by AI, enabling highly accurate reliability evaluation tailored to the characteristics of each type of information, and technically improves the risk of misjudgment and the soundness of information distribution. Application fields include SNS platforms, news distribution services, enterprise information sharing infrastructure, and information literacy support systems for educational institutions. Thus, the evaluation unit realizes an improvement in computer technology by applying category-specific evaluation criteria using AI, and can automatically perform optimized reliability evaluation for each information category.

The providing unit can estimate the user's emotion and adjust the content of warning messages based on that emotion. For example, if the user is excited, the providing unit provides warning messages in a calm manner. If the user is calm, the providing unit can provide warning messages in a normal manner. If the user is anxious, the providing unit can provide warning messages in a reassuring manner. Thus, by adjusting the content of warning messages according to the user's emotion, the providing unit can provide more appropriate information. Specifically, the providing unit inputs user-posted data and recent behavioral history, as well as posting metadata (e.g., posting time, presence of emojis, exclamation marks, past emotion scores) into an emotion estimation module, which outputs emotion labels (e.g., excited, calm, anxious) and emotion intensity scores (e.g., 0.12 to 0.98) using BERT-based encoders or multimodal Transformers. The AI model inputs the emotion estimation results into a warning message generation module, and automatically selects an expression method determination algorithm (e.g., calm expression template, normal expression template, reassurance emphasis template, etc.). For example, in the case of “excited”, a calm expression (e.g., “Please check”) is generated; in the case of “calm”, a normal expression (e.g., “This information may have low reliability”) is generated; and in the case of “anxious”, a reassurance emphasis expression (e.g., “Please rest assured. Reliable information sources are referenced”) is generated. Examples of output include “Warning message: Calm expression”, “Warning message: Reassurance emphasis”, etc. Based on the output of the AI model, the providing unit automatically switches the content of warning messages on the user interface, realizing information presentation optimized for the user's psychological state. For training the AI model, supervised learning using paired data of emotion state, expression method selection, and user response is applied. As a subsequent process, the result of warning message content adjustment is also linked to warning display, supplementary information presentation, and display order determination. As a technical effect, the providing unit, unlike conventional static warning messages, realizes emotion estimation and dynamic content adjustment by AI, thereby improving user experience, suppressing the spread of misinformation, and technically improving the soundness of information distribution. Application fields include SNS platforms, news distribution services, enterprise information sharing infrastructure, and information literacy support systems for educational institutions. Thus, the providing unit realizes an improvement in computer technology by emotion estimation and warning message content adjustment using AI, and can automatically present optimal information to the user.

The providing unit can adjust the level of detail of supplementary information based on the reliability score of the information. For example, for information with a high reliability score, detailed supplementary information is provided. For information with a low reliability score, the providing unit can provide concise supplementary information. The providing unit can use generative AI to evaluate the reliability score of information and adjust the level of detail of supplementary information based on that evaluation. Thus, by adjusting the level of detail of supplementary information according to the reliability score, the providing unit can appropriately provide the necessary information to the user. Specifically, the providing unit inputs multidimensional data such as reliability scores (e.g., 0.12 to 0.98) received from the evaluation unit or reliability evaluation unit, information category, and feature vectors of information content into a supplementary information detail adjustment module. This module uses Transformer-based regression or classification models to automatically determine the level of detail of supplementary information (e.g., detailed, standard, brief) according to the reliability score. Examples of input include “Reliability score: 0.95”, “Information category: social news”, “Information content: new technology announcement”, etc. The AI model outputs detail labels (e.g., detailed, standard, brief), recommended output templates (e.g., with detailed explanation, key points only), and example output texts (e.g., detailed supplementary information text, concise supplementary information text). Examples of output include “Level of detail: detailed”, “Supplementary information: with detailed explanation”, “Supplementary information: key points only”, etc. Based on the output of the AI model, the providing unit automatically switches the level of detail of supplementary information on the user interface, realizing information presentation optimized for the user's needs and the reliability of the information. For training the AI model, supervised learning using paired data of reliability score, detail selection, and user response is applied. As a subsequent process, the result of detail adjustment is also linked to warning display, supplementary information presentation, and display order determination. As a technical effect, the providing unit, unlike conventional uniform supplementary information presentation, realizes reliability score evaluation and dynamic detail adjustment by AI, thereby improving user experience, reducing the risk of information overload or insufficiency, and technically improving the efficiency and accuracy of information distribution. Application fields include SNS platforms, news distribution services, enterprise information sharing infrastructure, and information literacy support systems for educational institutions. Thus, the providing unit realizes an improvement in computer technology by reliability score evaluation and detail adjustment using AI, and can automatically present optimal information to the user.

The reliability evaluation unit can improve the accuracy of evaluation by referring to relevant literature and data when evaluating the reliability of news sources. For example, the reliability evaluation unit can use generative AI to refer to relevant literature and data. The reliability evaluation unit refers to relevant literature and data and can improve the accuracy of evaluation based on such references. For instance, the reliability evaluation unit refers to relevant literature and data and preferentially evaluates information from highly reliable news sources. Thus, by referring to relevant literature and data when evaluating the reliability of news sources, the reliability evaluation unit can improve the accuracy of evaluation. Specifically, the reliability evaluation unit receives structured data such as keywords related to news article data or posted data, source URLs, citation lists, DOI numbers, academic paper titles, statistical dataset IDs, etc. The input data is normalized, tokenized, and feature-extracted (e.g., contextual vectorization by BERT-based encoders, vectorization of literature metadata) in a preprocessing unit, and then input to an AI model for literature and data reference. This AI model uses Transformer-based information retrieval networks, literature summarization generation models, knowledge graph inference models, etc., to analyze semantic similarity and citation relationships between the input information and pre-constructed literature and databases (e.g., academic paper databases, statistical data repositories, lists of sources already evaluated for reliability, etc.). Examples of input include “Keyword: novel coronavirus”, “Source URL: https://example.com/data/123”, “DOI: 10.1234/abcd.2023.001”, etc. The AI model outputs related literature scores (e.g., 0.12 to 0.98), recommended reference literature lists (e.g., title, author, publication year), summary texts (e.g., summary of main research results), reliability evaluation correction values, and so on. Examples of output include “Related literature score: 0.95”, “Recommended literature: Smith et al., 2023”, “Summary: matches main research results”, etc. Based on the output of the AI model, the reliability evaluation unit preferentially evaluates information supported by highly reliable literature and data, and filters or displays warnings for news sources with low reliability or information with unclear sources. For training the AI model, supervised learning using pairs of literature/data reference history and reliability evaluation results, as well as relevance inference by knowledge graph expansion, are applied. As a subsequent process, literature reference results are also linked to warning generation, supplementary information presentation, and display order determination. As a technical effect, the reliability evaluation unit, unlike conventional manual literature surveys or static reference lists, realizes dynamic literature/data reference and semantic similarity analysis by AI, enabling highly accurate reliability evaluation based on evidence, and technically improving the suppression of misinformation and the soundness of information distribution. Application fields include news distribution services, academic information distribution infrastructure, enterprise knowledge management, and information literacy support for educational institutions. Thus, the reliability evaluation unit realizes an improvement in computer technology by literature/data reference and accuracy improvement using AI, and can automatically perform evidence-based reliability evaluation.

The display unit can estimate the user's emotion and adjust the display method based on that emotion. For example, if the user is excited, the display unit provides a simple and highly visible display method. If the user is calm, the display unit can provide a display method that includes detailed information. If the user is anxious, the display unit can provide a display method that gives reassurance. Thus, by adjusting the display method according to the user's emotion, the display unit can provide more appropriate information. Specifically, the display unit inputs user-posted data (e.g., text, images, videos, links, etc.), recent behavioral history, and posting metadata (e.g., posting time, presence of emojis, exclamation marks, past emotion scores) into an emotion estimation module. This emotion estimation module uses BERT-based encoders or multimodal Transformers to output emotion labels (e.g., excited, calm, anxious) and emotion intensity scores (e.g., 0.12 to 0.98) from the input data. Examples of input include “Post text: ‘XX went bankrupt today’”, “Emoji: [symbol] ”, “Emotion intensity: 0.93 (excited)”, etc. The AI model inputs the emotion estimation results into a display method determination module, and automatically selects display templates (e.g., simple display, detailed display, reassurance emphasis display) and layout parameters (e.g., font size, color scheme, degree of emphasis). For example, in the case of “excited”, a simple card-type display with reduced information volume or color schemes that emphasize only important information are applied; in the case of “calm”, a rich display with detailed explanations and related information links is generated; and in the case of “anxious”, a display with reassuring color schemes (e.g., blue tones), supplementary explanations, and FAQ links is generated. Examples of output include “Display template: simple”, “Emphasis color: red”, “Supplementary information: reassurance emphasis”, etc. Based on the output of the AI model, the display unit automatically switches the display method on the user interface, realizing information presentation optimized for the user's psychological state and the importance of the information. For training the AI model, supervised learning using paired data of emotion state, display method selection, and user response is applied. As a subsequent process, the result of display method adjustment is also linked to warning display, supplementary information presentation, and display order determination. As a technical effect, the display unit, unlike conventional static display methods, realizes emotion estimation and dynamic display method adjustment by AI, thereby improving user experience, suppressing the spread of misinformation, and technically improving the soundness of information distribution. Application fields include SNS platforms, news distribution services, enterprise information sharing infrastructure, and information literacy support systems for educational institutions. Thus, the display unit realizes an improvement in computer technology by emotion estimation and display method adjustment using AI, and can automatically present optimal information to the user.

The receiving unit can preferentially receive highly relevant information by considering the user's geographic location information. For example, information related to the region where the user is currently located can be preferentially received. The receiving unit can use generative AI to identify the user's geographic location information and filter information based on that location information. Thus, by considering the user's geographic location information, the receiving unit can preferentially receive highly relevant information. Specifically, the receiving unit uses GPS coordinates, IP addresses, Wi-Fi access point information, etc., obtained from the user's terminal to accurately identify the user's current location. This location information is processed in a preprocessing unit by geocoding (e.g., converting latitude and longitude to prefecture/city/town), and vectorized by location category (e.g., one-hot vectorization for each location category), and then input to an AI model for location information filtering. This AI model uses multiclass classification networks or location-embedded information recommendation models (e.g., location embedding+Transformer) to determine the relevance between location information and posted content. Examples of input include “User location: Chiyoda-ku, Tokyo”, “Post content: Tokyo event information”, “Location category: urban area”, etc. The AI model outputs relevance scores (e.g., 0.12 to 0.98), priority receiving labels (e.g., high, medium, low), and recommended reasons (e.g., region match degree 0.95). Examples of output include “Relevance score: 0.93”, “Priority receiving: high”, “Recommended reason: user location matches post content”, etc. Based on the output of the AI model, the receiving unit preferentially receives information related to the user's current location, and excludes or displays warnings for information with low relevance from the receiving candidates. For training the AI model, supervised learning using pairs of location-tagged posted data and relevance annotations, as well as geographic clustering for extracting regional characteristics, are applied. As a subsequent process, the result of location information filtering is also linked to reliability evaluation of posted content and warning generation. As a technical effect, the receiving unit, unlike conventional static region category selection or manual filtering, realizes dynamic location estimation and information receiving filtering by AI, thereby promoting region-specific information distribution, suppressing the inflow of noise information, and technically improving the relevance of information and user experience. Application fields include regional SNS, local news distribution services, municipal information sharing infrastructure, and disaster information transmission systems. Thus, the receiving unit realizes an improvement in computer technology by location estimation and information filtering using AI, and can automatically perform optimal information receiving for the user.

The evaluation unit can estimate the user's emotion and adjust the order in which the results of reliability evaluation are displayed based on that emotion. For example, if the user is excited, the evaluation unit preferentially displays highly reliable information. If the user is calm, the evaluation unit can display the results of reliability evaluation in the normal order. If the user is anxious, the evaluation unit can preferentially display information that gives reassurance. Thus, by adjusting the order in which the results of reliability evaluation are displayed according to the user's emotion, the evaluation unit can provide optimal information to the user. Specifically, the evaluation unit inputs user-posted data and recent behavioral history, as well as posting metadata (e.g., posting time, presence of emojis, exclamation marks, past emotion scores) into an emotion estimation module, which outputs emotion labels (e.g., excited, calm, anxious) and emotion intensity scores (e.g., 0.12 to 0.98) using BERT-based encoders or multimodal Transformers. The AI model inputs the emotion estimation results and reliability evaluation results (e.g., reliability score, label, information category, importance score, etc.) into a priority determination module, and controls the display so that, for example, when the emotional state is “excited”, information with a high reliability score (e.g., score 0.95 or higher) is displayed at the top; when “calm”, the normal score order is used; and when “anxious”, information that gives reassurance (e.g., announcements from public institutions, FAQs, etc.) is displayed at the top. Examples of input include “Emotion label: excited”, “Reliability score: 0.97”, “Information category: social news”, etc. The AI model outputs display order (e.g., 1st: public institution announcement, 2nd: major news agency, 3rd: general news) and emphasis display methods (e.g., color coding, icon attachment). Examples of output include “Display order: 1st (high reliability)”, “Display order: 2nd (reassurance emphasis)”, etc. These outputs are also linked to display control on the user interface and warning/supplementary information presentation. For training the AI model, supervised learning using paired data of emotion state, display order selection, and user response is applied. As a technical effect, the evaluation unit, unlike conventional static display order control, realizes emotion estimation and dynamic display order adjustment by AI, enabling information presentation tailored to the user's psychological state and the importance of information, and technically improving user experience by reducing the risk of information oversight and misinformation spread. Application fields include SNS platforms, news distribution services, enterprise information sharing infrastructure, and information literacy support systems for educational institutions. Thus, the evaluation unit realizes an improvement in computer technology by emotion estimation and display order adjustment using AI, and can automatically present optimal information to the user.

The providing unit can determine the priority of provision of warnings or supplementary information based on the submission timing of the information. For example, for the latest information, warnings or supplementary information are provided preferentially. For older information, the providing unit can lower the priority of provision. The providing unit can use generative AI to identify the submission timing of information and determine the priority of provision based on that timing. Thus, by determining the priority of provision based on the submission timing of information, the providing unit can preferentially provide the latest information. Specifically, the providing unit inputs structured data such as submission time (e.g., timestamp, posting date, article publication date, etc.), information category, and reliability score received from the evaluation unit or reliability evaluation unit into a priority determination module. This module uses time-series analysis AI models (e.g., LSTM, Transformer-based time-series classifiers) to calculate indicators of novelty and freshness of information (e.g., difference from current time, comparison with past diffusion records, etc.), and automatically determines priority labels (e.g., high, medium, low), display order, and timing of warning/supplementary information presentation. Examples of input include “Submission time: 2024-06-01 12:00”, “Information category: economy”, “Reliability score: 0.92”, etc. The AI model outputs priority (e.g., latest information prioritized), recommended display timing (e.g., immediate, delayed, hidden), and output templates (e.g., for breaking news, for normal use, etc.). Examples of output include “Priority: high (latest information)”, “Display timing: immediate”, “Warning message: for breaking news”, etc. Based on the output of the AI model, the providing unit preferentially presents the latest information as warnings or supplementary information on the user interface, and lowers the priority or hides older information. For training the AI model, supervised learning using paired data of information submission timing, priority selection, and user response, as well as time-series clustering for optimizing information freshness, are applied. As a subsequent process, the result of priority determination is also linked to warning display, supplementary information presentation, and display order determination. As a technical effect, the providing unit, unlike conventional static information presentation, realizes submission timing analysis and dynamic priority determination by AI, enabling highly accurate information provision tailored to information freshness, and technically improving the efficiency and accuracy of information distribution by reducing the risk of information oversight and misinformation spread. Application fields include SNS platforms, news distribution services, enterprise information sharing infrastructure, and information literacy support systems for educational institutions. Thus, the providing unit realizes an improvement in computer technology by submission timing analysis and priority determination using AI, and can automatically present optimal information to the user.

The reliability evaluation unit can estimate the user's emotion and adjust the reliability evaluation criteria for news sources based on that emotion. For example, if the user is excited, the reliability evaluation unit applies strict reliability evaluation criteria. If the user is calm, the reliability evaluation unit can apply normal reliability evaluation criteria. If the user is anxious, the reliability evaluation unit can apply reliability evaluation criteria that provide reassurance. Thus, by adjusting the reliability evaluation criteria according to the user's emotion, the reliability evaluation unit can perform more appropriate reliability evaluation. Specifically, the reliability evaluation unit inputs user-posted data (e.g., text, images, videos, links, etc.) and posting metadata (e.g., posting time, presence of emojis, exclamation marks, past emotion scores) into an emotion estimation module. This emotion estimation module uses BERT-based encoders or multimodal Transformers to output emotion labels (e.g., excited, calm, anxious) and emotion intensity scores (e.g., 0.12 to 0.98) from the input data. Examples of input include “Post text: ‘XX went bankrupt today’”, “Emoji: [symbol] ”, “Emotion intensity: 0.93 (excited)”, etc. The reliability evaluation unit inputs the emotion estimation results into a reliability evaluation criteria adjustment module, and, for example, in the case of “excited”, raises the fact-checking threshold to 0.95 and adds several strict evaluation items such as reference to the past misinformation rate of the information source and the presence of third-party authentication. In the case of “calm”, the normal threshold (e.g., 0.85) and standard evaluation items are applied, and in the case of “anxious”, highly reliable information sources such as public institutions and FAQs are preferentially referenced to provide reassurance. Examples of AI model output include “Applied evaluation criteria: strict (threshold 0.95, reference to misinformation rate)”, “Applied evaluation criteria: standard (threshold 0.85)”, “Applied evaluation criteria: reassurance emphasis (public institution prioritized)”, etc. These criteria adjustments are also linked to subsequent processes such as reliability score calculation, warning generation, and supplementary information presentation. For training the AI model, supervised learning using paired data of emotion state, criteria selection, and evaluation results is applied. As a technical effect, the reliability evaluation unit, unlike conventional static criteria application, realizes emotion estimation and dynamic criteria adjustment by AI, enabling flexible and highly accurate reliability evaluation tailored to the user's psychological state and information distribution risk, and technically improving the risk of misjudgment and the soundness of information distribution. Application fields include SNS platforms, news distribution services, enterprise information sharing infrastructure, and information literacy support systems for educational institutions. Thus, the reliability evaluation unit realizes an improvement in computer technology by emotion estimation and criteria adjustment using AI, and can automatically perform reliability evaluation optimized for each user.

The following is a brief description of the processing flow of Example of the Embodiment. Specifically, the present system realizes a series of data flows from receiving information from the user to final information presentation, with each module such as the receiving unit, evaluation unit, providing unit, reliability evaluation unit, and display unit working in cooperation. The receiving unit receives various input data such as user-posted data (e.g., text, images, videos, links, etc.), behavioral history, geographic location information, social media activity, etc., performs normalization and feature extraction in a preprocessing unit, and inputs the data to AI models for estimating fields of interest, analyzing posting history, filtering location information, etc. The evaluation unit uses reliability evaluation AI models (e.g., application of category-specific evaluation criteria, reference to past history, reference to literature and data, etc.) to calculate reliability scores and evaluation labels for information received from the receiving unit, and outputs parameters for warning generation and supplementary information generation. The providing unit uses warning/supplementary information generation AI models (e.g., emotion estimation-linked type, detail adjustment type, category-specific template application type, etc.) based on the output of the evaluation unit to generate optimal information presentation content according to the user's psychological state and the importance and reliability of the information. The reliability evaluation unit uses news source reliability evaluation AI models (e.g., reference to past history, application of category-specific evaluation methods, geographic distribution analysis, reference to literature and data, etc.) to accurately evaluate the reliability and credibility of information sources, and links the evaluation results to the providing unit and display unit. The display unit comprehensively considers the emotion estimation results, device information, operation history, information category, relevance score, etc., based on information received from the reliability evaluation unit and providing unit, and automatically determines the optimal display method, display order, emphasis display, etc., to present information on the user interface. For training each AI model, supervised learning using paired data of user behavior data, evaluation results, display history, user response, etc., as well as clustering, anomaly detection, and knowledge graph inference methods are applied. Thus, the present system, unlike conventional static and uniform information distribution control, realizes dynamic and individually optimized information receiving, evaluation, provision, and display by AI, and exhibits technical effects such as improvement of user experience, suppression of misinformation spread, and enhancement of the soundness of information distribution. Application fields include SNS platforms, news distribution services, enterprise information sharing infrastructure, information literacy support systems for educational institutions, and disaster information transmission systems.

Step 1: The receiving unit receives information shared by a user. For example, information such as text, images, and videos posted by a user on a social media platform can be received. Step 2: The evaluation unit uses generative AI to evaluate the reliability of the information received by the receiving unit. For example, a reliability score of the information source is calculated, and the reliability of the information is evaluated based on that score. In addition, the past reliability history of the information source can be referenced to improve the accuracy of evaluation. Step 3: The providing unit provides warnings or supplementary information based on the information evaluated by the evaluation unit. For example, a warning such as “This information may have low reliability” can be displayed. Supplementary information from highly reliable information sources can also be provided. Step 4: The reliability evaluation unit uses generative AI to evaluate the reliability and credibility of news sources. For example, the reliability and credibility of news sources are evaluated based on information that has been fact-checked in advance or reliable media. In addition, the past reliability history of news sources can be referenced to improve the accuracy of evaluation. Step 5: The display unit preferentially displays reliable information evaluated by the reliability evaluation unit. For example, information from highly reliable news sources is preferentially displayed. In addition, generative AI can be used to estimate the user's emotion and adjust the display method based on the estimated emotion. Specifically, in Step 1, the receiving unit receives various input data such as user-posted data (e.g., text, images, videos, links, etc.), behavioral history, geographic location information, social media activity, etc., performs normalization and feature extraction in a preprocessing unit, and inputs the data to AI models for estimating fields of interest, analyzing posting history, filtering location information, etc. In Step 2, the evaluation unit uses reliability evaluation AI models (e.g., application of category-specific evaluation criteria, reference to past history, reference to literature and data, etc.) to calculate reliability scores and evaluation labels for information received from the receiving unit, and outputs parameters for warning generation and supplementary information generation. In Step 3, the providing unit uses warning/supplementary information generation AI models (e.g., emotion estimation-linked type, detail adjustment type, category-specific template application type, etc.) based on the output of the evaluation unit to generate optimal information presentation content according to the user's psychological state and the importance and reliability of the information. In Step 4, the reliability evaluation unit uses news source reliability evaluation AI models (e.g., reference to past history, application of category-specific evaluation methods, geographic distribution analysis, reference to literature and data, etc.) to accurately evaluate the reliability and credibility of information sources, and links the evaluation results to the providing unit and display unit. In Step 5, the display unit comprehensively considers the emotion estimation results, device information, operation history, information category, relevance score, etc., based on information received from the reliability evaluation unit and providing unit, and automatically determines the optimal display method, display order, emphasis display, etc., to present information on the user interface. For training each AI model, supervised learning using paired data of user behavior data, evaluation results, display history, user response, etc., as well as clustering, anomaly detection, and knowledge graph inference methods are applied. Thus, the present system, unlike conventional static and uniform information distribution control, realizes dynamic and individually optimized information receiving, evaluation, provision, and display by AI, and exhibits technical effects such as improvement of user experience, suppression of misinformation spread, and enhancement of the soundness of information distribution. Application fields include SNS platforms, news distribution services, enterprise information sharing infrastructure, information literacy support systems for educational institutions, and disaster information transmission systems.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned receiving unit, evaluation unit, providing unit, reliability evaluation unit, and display unit is implemented by at least one of, for example, the smart device 14 and the data processing apparatus 12. For example, the receiving unit is implemented by a control unit 46A of the smart device 14 and receives information posted by a user on a social media platform. The evaluation unit is implemented, for example, by a specific processing unit 290 of the data processing apparatus 12 and evaluates the reliability of information using generative AI. The providing unit is implemented, for example, by the control unit 46A of the smart device 14 and provides warnings or supplementary information. The reliability evaluation unit is implemented, for example, by the specific processing unit 290 of the data processing apparatus 12 and evaluates the reliability and credibility of news sources. The display unit is implemented, for example, by the control unit 46A of the smart device 14 and preferentially displays highly reliable information. The correspondence between each unit and the apparatus or control unit is not limited to the examples described above and various modifications are possible.

### Second Embodiment

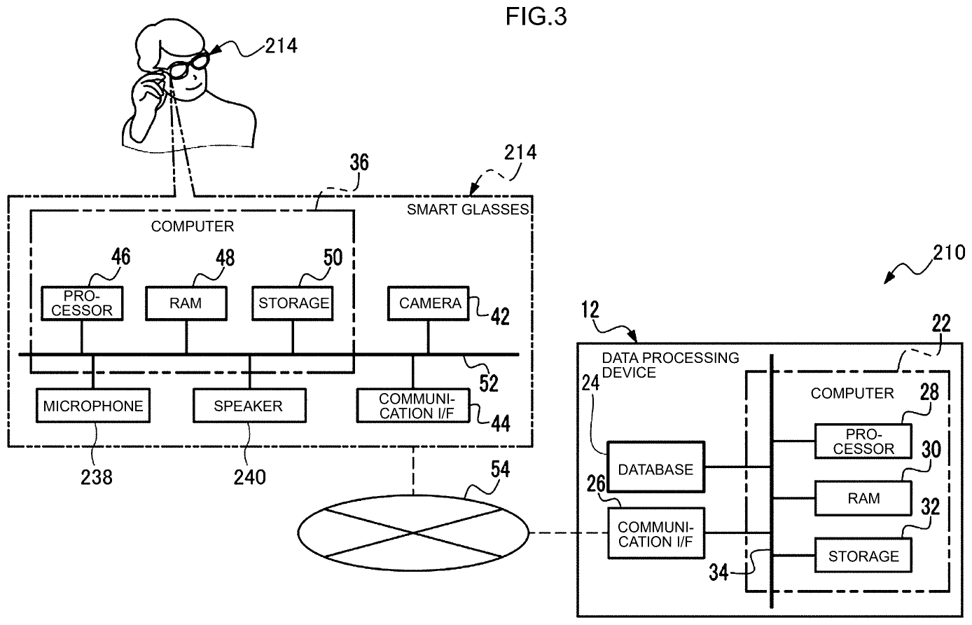

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

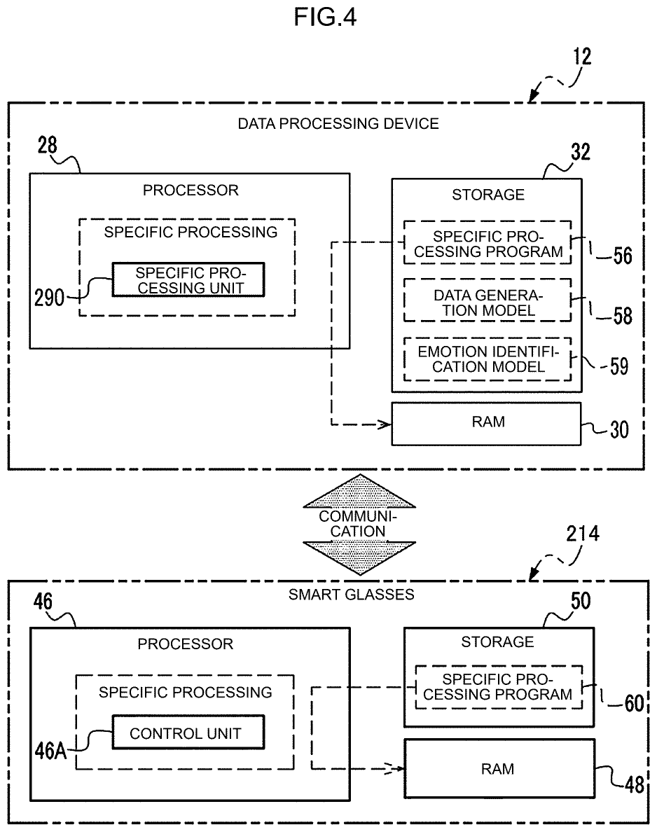

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned receiving unit, evaluation unit, providing unit, reliability evaluation unit, and display unit is implemented by at least one of, for example, the smart glasses 214 and the data processing apparatus 12. For example, the receiving unit is implemented by a control unit 46A of the smart glasses 214 and receives information posted by a user on a social media platform. The evaluation unit is implemented, for example, by a specific processing unit 290 of the data processing apparatus 12 and evaluates the reliability of information using generative AI. The providing unit is implemented, for example, by the control unit 46A of the smart glasses 214 and provides warnings or supplementary information. The reliability evaluation unit is implemented, for example, by the specific processing unit 290 of the data processing apparatus 12 and evaluates the reliability and credibility of news sources. The display unit is implemented, for example, by the control unit 46A of the smart glasses 214 and preferentially displays highly reliable information. The correspondence between each unit and the apparatus or control unit is not limited to the examples described above and various modifications are possible.

### Third Embodiment

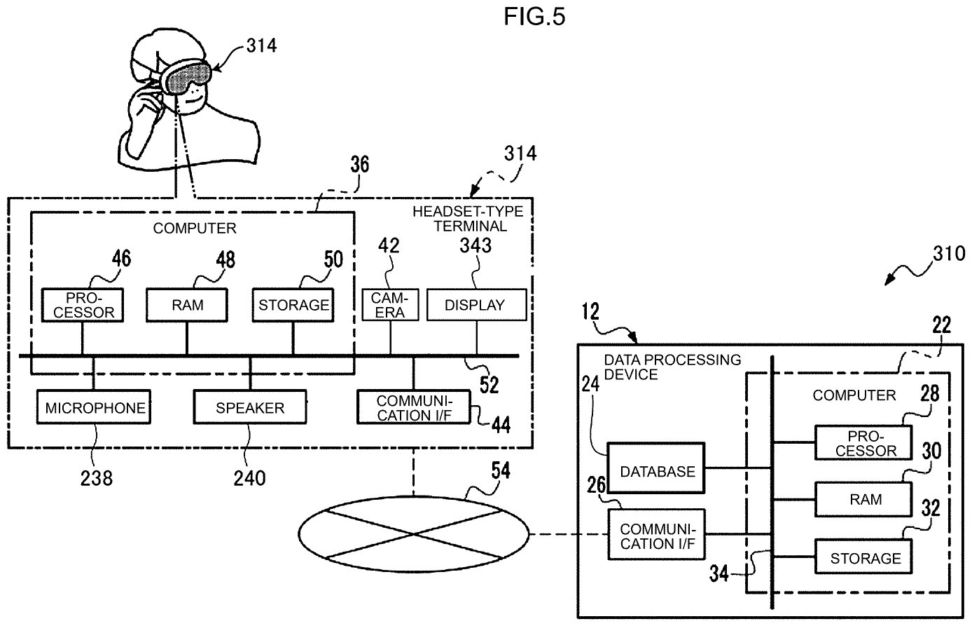

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

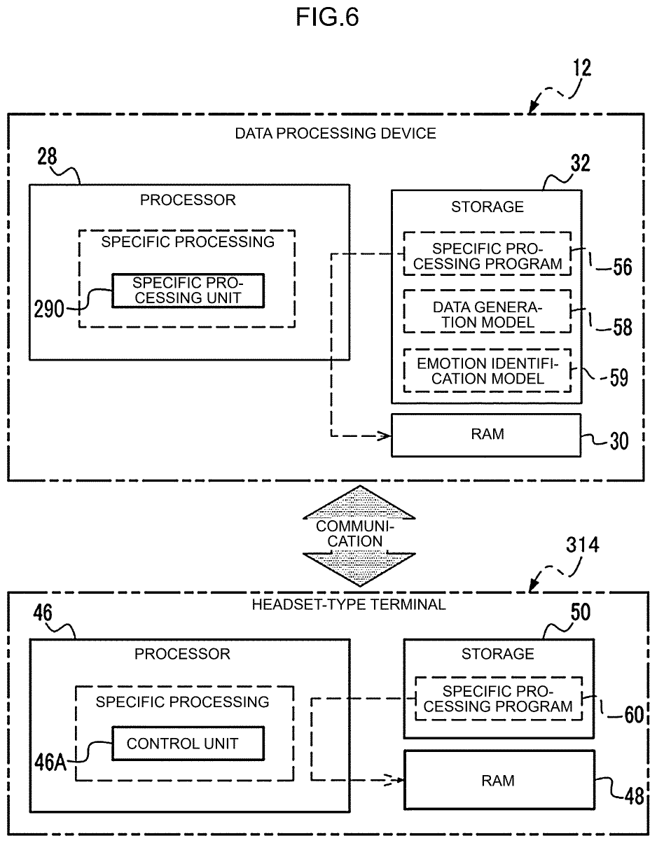

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned receiving unit, evaluation unit, providing unit, reliability evaluation unit, and display unit is implemented by at least one of, for example, the headset-type terminal 314 and the data processing apparatus 12. For example, the receiving unit is implemented by a control unit 46A of the headset-type terminal 314 and receives information posted by a user on a social media platform. The evaluation unit is implemented, for example, by a specific processing unit 290 of the data processing apparatus 12 and evaluates the reliability of information using generative AI. The providing unit is implemented, for example, by the control unit 46A of the headset-type terminal 314 and provides warnings or supplementary information. The reliability evaluation unit is implemented, for example, by the specific processing unit 290 of the data processing apparatus 12 and evaluates the reliability and credibility of news sources. The display unit is implemented, for example, by the control unit 46A of the headset-type terminal 314 and preferentially displays highly reliable information. The correspondence between each unit and the apparatus or control unit is not limited to the examples described above and various modifications are possible.

### Fourth Embodiment

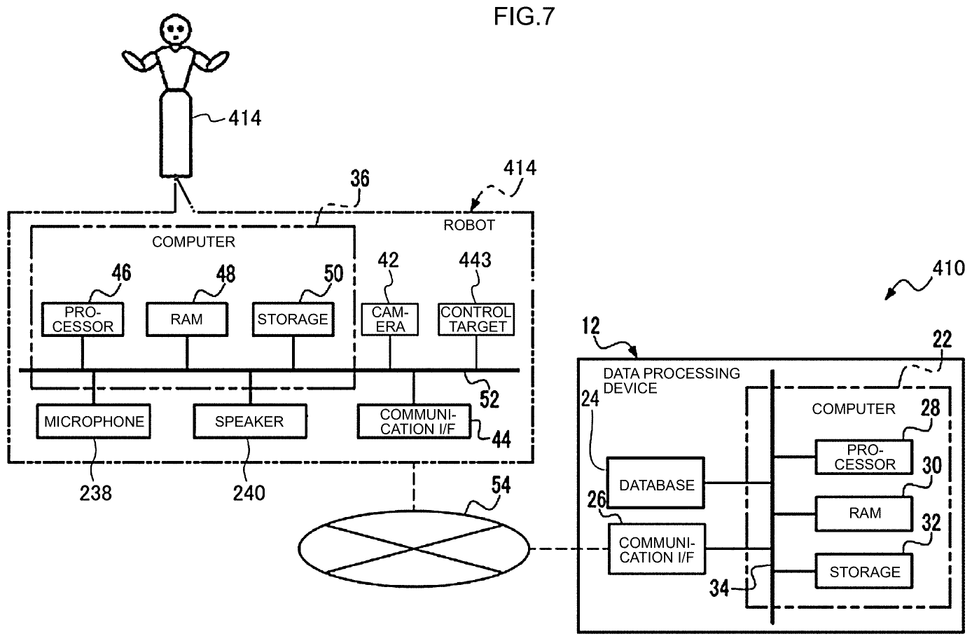

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

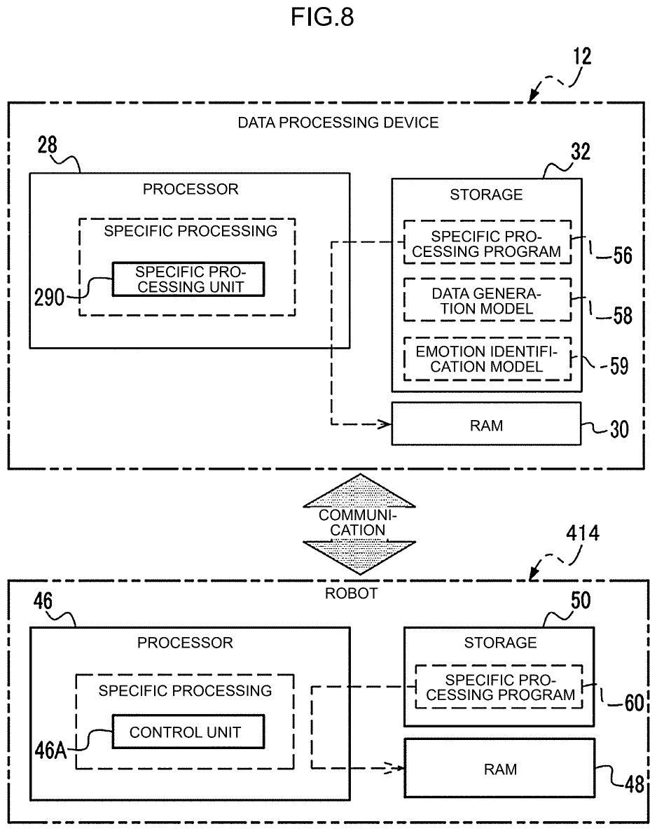

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned receiving unit, evaluation unit, providing unit, reliability evaluation unit, and display unit is implemented by at least one of, for example, the robot 414 and the data processing apparatus 12. For example, the receiving unit is implemented by a control unit 46A of the robot 414 and receives information posted by a user on a social media platform. The evaluation unit is implemented, for example, by a specific processing unit 290 of the data processing apparatus 12 and evaluates the reliability of information using generative AI. The providing unit is implemented, for example, by the control unit 46A of the robot 414 and provides warnings or supplementary information. The reliability evaluation unit is implemented, for example, by the specific processing unit 290 of the data processing apparatus 12 and evaluates the reliability and credibility of news sources. The display unit is implemented, for example, by the control unit 46A of the robot 414 and preferentially displays highly reliable information. The correspondence between each unit and the apparatus or control unit is not limited to the examples described above and various modifications are possible.

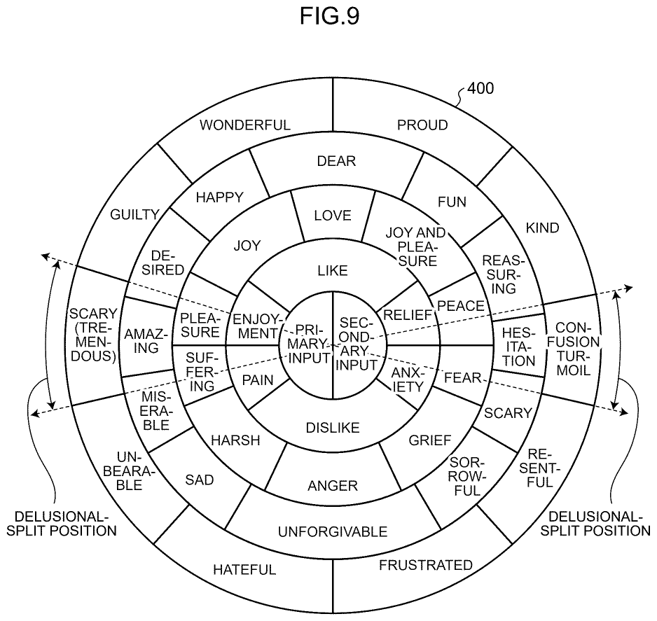

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

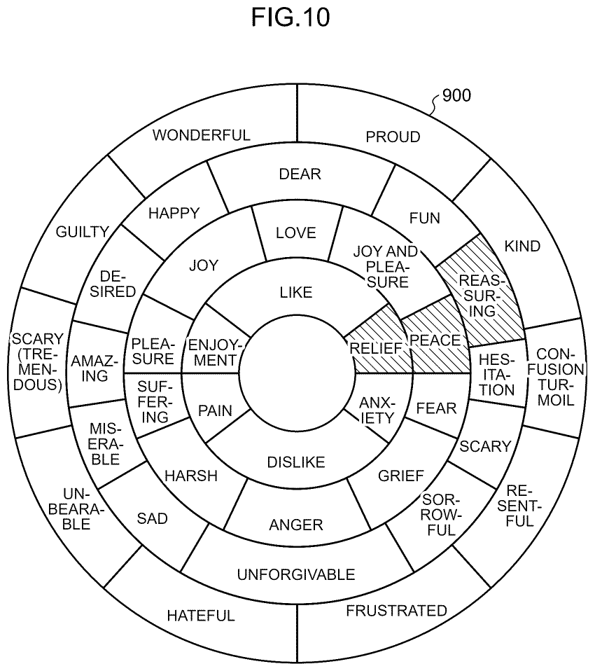

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a receiving unit configured to receive information shared by a user; an evaluation unit configured to evaluate the reliability of the information received by the receiving unit; a providing unit configured to provide a warning or supplementary information based on the information evaluated by the evaluation unit; a reliability evaluation unit configured to evaluate the reliability and credibility of news sources; and a display unit configured to preferentially display reliable information evaluated by the reliability evaluation unit.
(Supplementary Note 2) The system according to Supplementary Note 1, wherein the evaluation unit calculates a reliability score of an information source and evaluates the reliability of the information based on the score.
(Supplementary Note 3) The system according to Supplementary Note 1, wherein the providing unit displays a warning such as “This information has low reliability.”
(Supplementary Note 4) The system according to Supplementary Note 1, wherein the providing unit provides supplementary information from highly reliable information sources.
(Supplementary Note 5) The system according to Supplementary Note 1, wherein the reliability evaluation unit evaluates the reliability and credibility of news sources based on information that has been fact-checked in advance or reliable media.
(Supplementary Note 6) The system according to Supplementary Note 1, wherein the display unit preferentially displays information from highly reliable news sources.
(Supplementary Note 7) The system according to Supplementary Note 1, wherein the receiving unit estimates the user's emotion and adjusts the timing of receiving information based on the emotion.
(Supplementary Note 8) The system according to Supplementary Note 1, wherein the receiving unit analyzes the user's past information sharing history and selects an appropriate receiving method.
(Supplementary Note 9) The system according to Supplementary Note 1, wherein the receiving unit performs filtering based on the user's current field of interest at the time of receiving information.
(Supplementary Note 10) The system according to Supplementary Note 1, wherein the receiving unit estimates the user's emotion and determines the priority of information to be received based on the emotion.
(Supplementary Note 11) The system according to Supplementary Note 1, wherein the receiving unit, at the time of receiving information, preferentially receives highly relevant information by considering the user's geographic location information.
(Supplementary Note 12) The system according to Supplementary Note 1, wherein the receiving unit, at the time of receiving information, analyzes the user's social media activity and receives relevant information.
(Supplementary Note 13) The system according to Supplementary Note 1, wherein the evaluation unit estimates the user's emotion and adjusts the criteria for evaluating the reliability of information based on the emotion.
(Supplementary Note 14) The system according to Supplementary Note 1, wherein the evaluation unit, when evaluating the reliability of information, refers to the past reliability history of the information source to improve the accuracy of the evaluation.
(Supplementary Note 15) The system according to Supplementary Note 1, wherein the evaluation unit, when evaluating the reliability of information, applies different evaluation algorithms for each category of information.
(Supplementary Note 16) The system according to Supplementary Note 1, wherein the evaluation unit estimates the user's emotion and adjusts the order in which the results of reliability evaluation are displayed based on the emotion.
(Supplementary Note 17) The system according to Supplementary Note 1, wherein the evaluation unit, when evaluating the reliability of information, performs evaluation by considering the geographic distribution of the information.
(Supplementary Note 18) The system according to Supplementary Note 1, wherein the evaluation unit, when evaluating the reliability of information, refers to related literature or data to improve the accuracy of the evaluation.
(Supplementary Note 19) The system according to Supplementary Note 1, wherein the providing unit estimates the user's emotion and adjusts the method of expressing warnings or supplementary information based on the emotion.
(Supplementary Note 20) The system according to Supplementary Note 1, wherein the providing unit, when providing warnings or supplementary information, adjusts the level of detail of the provision based on the importance of the information.
(Supplementary Note 21) The system according to Supplementary Note 1, wherein the providing unit, when providing warnings or supplementary information, applies different providing algorithms according to the category of information.
(Supplementary Note 22) The system according to Supplementary Note 1, wherein the providing unit estimates the user's emotion and adjusts the length of warnings or supplementary information based on the emotion.
(Supplementary Note 23) The system according to Supplementary Note 1, wherein the providing unit, when providing warnings or supplementary information, determines the priority of provision based on the submission timing of the information.
(Supplementary Note 24) The system according to Supplementary Note 1, wherein the providing unit, when providing warnings or supplementary information, adjusts the order of provision based on the relevance of the information.
(Supplementary Note 25) The system according to Supplementary Note 1, wherein the reliability evaluation unit estimates the user's emotion and adjusts the criteria for evaluating the reliability of news sources based on the emotion.
(Supplementary Note 26) The system according to Supplementary Note 1, wherein the reliability evaluation unit, when evaluating the reliability of news sources, refers to past evaluation data to improve the accuracy of the evaluation.
(Supplementary Note 27) The system according to Supplementary Note 1, wherein the reliability evaluation unit, when evaluating the reliability of news sources, applies different evaluation methods for each category of information.
(Supplementary Note 28) The system according to Supplementary Note 1, wherein the reliability evaluation unit estimates the user's emotion and adjusts the order in which the results of reliability evaluation are displayed based on the emotion.
(Supplementary Note 29) The system according to Supplementary Note 1, wherein the reliability evaluation unit, when evaluating the reliability of news sources, performs evaluation by considering the geographic distribution of the information.
(Supplementary Note 30) The system according to Supplementary Note 1, wherein the reliability evaluation unit, when evaluating the reliability of news sources, refers to related literature or data to improve the accuracy of the evaluation.
(Supplementary Note 31) The system according to Supplementary Note 1, wherein the display unit estimates the user's emotion and adjusts the display method based on the emotion.
(Supplementary Note 32) The system according to Supplementary Note 1, wherein the display unit, at the time of display, refers to the user's past operation history and selects an optimal display method.
(Supplementary Note 33) The system according to Supplementary Note 1, wherein the display unit, at the time of display, applies different display algorithms according to the category of information.
(Supplementary Note 34) The system according to Supplementary Note 1, wherein the display unit estimates the user's emotion and determines the priority of display based on the emotion.
(Supplementary Note 35) The system according to Supplementary Note 1, wherein the display unit, at the time of display, selects an optimal display method by considering the user's device information.
(Supplementary Note 36) The system according to Supplementary Note 1, wherein the display unit, at the time of display, adjusts the order of display based on the relevance of the information.

What is claimed is:

1. A system comprising:
circuitry configured to:
receive, via a packet-switched network, input data from a client terminal, the input data comprising at least one of text data, image data, or link data associated with a posting operation by a user;
generate a feature vector by applying an encoder neural network to the input data, the encoder neural network comprising a multi-layer self-attention mechanism that produces a multidimensional tensor representation of the input data;
compute a classification score by calculating a similarity metric between the feature vector and a plurality of reference vectors stored in a database, each reference vector corresponding to a previously verified data entry;
generate annotation data based on the classification score, the annotation data comprising at least one of a label indicating a confidence level of the input data or supplementary text derived from a subset of the reference vectors having similarity metrics exceeding a threshold; and
transmit the annotation data to the client terminal via the packet-switched network, the annotation data causing the client terminal to render the annotation data in association with the input data on a display of the client terminal.

2. The system according to claim 1, wherein the circuitry is further configured to calculate the classification score by applying a scoring algorithm that computes a weighted combination of a source credibility metric and a historical performance metric associated with an origin of the input data.

3. The system according to claim 1, wherein the supplementary text is generated by the circuitry searching a corpus of verified data entries having classification scores exceeding a second threshold and summarizing content of the verified data entries using a data generation model comprising an encoder-decoder neural network.

4. The system according to claim 1, wherein the circuitry is further configured to compute a source reliability metric for each of a plurality of source identifiers by matching each source identifier against a fact-checked reference database storing embedding vectors of previously verified content, and to weight the classification score based on the source reliability metric.

5. The system according to claim 1, wherein the circuitry is further configured to determine a display order for a plurality of data items based on respective classification scores of the data items, and to transmit display order data to the client terminal that causes the client terminal to render data items having classification scores exceeding the threshold at a higher position than data items having classification scores below the threshold.

6. The system according to claim 1, wherein the circuitry is further configured to estimate an emotion of the user by applying an emotion identification model to at least one of the text data or metadata associated with the posting operation, and to adjust a timing of processing the input data based on the estimated emotion.

7. The system according to claim 1, wherein the circuitry is further configured to analyze a posting history of the user stored in the database, the posting history comprising data types and posting frequencies, and to select a preprocessing method for the input data based on the posting history.

8. The system according to claim 1, wherein the circuitry is further configured to determine a field of interest of the user by applying a classification model to a behavioral history of the user, and to filter the input data based on a relevance score between the input data and the determined field of interest.

9. The system according to claim 1, wherein the circuitry is further configured to estimate an emotion of the user and to determine a priority of processing the input data based on the estimated emotion, wherein a first priority level is assigned when the estimated emotion indicates an excited state and a second priority level is assigned when the estimated emotion indicates a calm state.

10. The system according to claim 1, wherein the circuitry is further configured to acquire geographic location data of the client terminal and to filter the input data based on a geographic relevance score computed by comparing the geographic location data with location metadata associated with the input data.

11. The system according to claim 1, wherein the circuitry is further configured to estimate an emotion of the user and to adjust the threshold used for computing the classification score based on the estimated emotion, wherein the threshold is set to a first value when the estimated emotion indicates an excited state and to a second value lower than the first value when the estimated emotion indicates a calm state.

12. The system according to claim 1, wherein the circuitry is further configured to retrieve, from the database, a time series of historical classification scores associated with an origin of the input data, and to apply a trend analysis using a recurrent neural network to the time series to generate a credibility weight that modifies the classification score.

13. The system according to claim 1, wherein the circuitry is further configured to classify the input data into a category using a text classification model, and to select an evaluation algorithm from a plurality of evaluation algorithms based on the category, each evaluation algorithm applying different weighting parameters to the similarity metric calculation.

14. The system according to claim 1, wherein the circuitry is further configured to estimate an emotion of the user and to adjust a textual expression of the annotation data based on the estimated emotion, the adjustment comprising selecting one of a plurality of output templates corresponding to different emotion states.

15. The system according to claim 1, wherein the circuitry is further configured to compute an importance score for the input data based on at least one of a dissemination speed or a number of related postings, and to adjust a level of detail of the annotation data based on the importance score.

16. The system according to claim 1, wherein the circuitry is further configured to determine a provision priority for the annotation data based on a submission timestamp of the input data, the provision priority being higher for input data having a more recent submission timestamp.

17. The system according to claim 1, wherein the circuitry is further configured to extract geographic metadata from the input data, to compute a geographic distribution pattern using a graph neural network that analyzes location features associated with the input data and the reference vectors, and to adjust the classification score based on the geographic distribution pattern.

18. A system comprising:
circuitry configured to:
receive, via a packet-switched network, input data from a client terminal, the input data comprising at least one of text data, image data, video data, or link data associated with a posting operation by a user on a content sharing platform;
perform preprocessing on the input data comprising normalization, tokenization using subword segmentation, and feature extraction, the feature extraction comprising generating a contextual embedding using a BERT-series encoder for the text data and extracting a feature map using a convolutional neural network for the image data;
generate a multidimensional feature vector by applying a Transformer-based encoder comprising a multi-layer self-attention mechanism to the preprocessed input data;
compute a classification score by calculating a cosine similarity between the multidimensional feature vector and each of a plurality of reference vectors stored in a fact-checked reference database, each reference vector being an embedding vector of a previously verified data entry;
determine, based on the classification score exceeding a threshold, that the input data corresponds to a known misinformation entry, and generate an alert message;
retrieve, from the fact-checked reference database, supplementary content from a subset of the reference vectors having cosine similarity values exceeding a second threshold, and generate a summary of the supplementary content using a data generation model comprising an encoder-decoder neural network;
estimate an emotion of the user by applying an emotion identification model to the input data, the emotion identification model outputting an emotion label and an emotion intensity score; and
adjust a display format of the alert message and the summary based on the emotion label, and transmit the alert message and the summary to the client terminal via the packet-switched network.

19. The system according to claim 18, wherein the emotion identification model comprises a multimodal Transformer architecture that receives at least one of the text data, frequency data of emojis and punctuation marks in the text data, a posting timestamp, and a historical emotion score of the user, and outputs the emotion label selected from a set comprising an excited state, a calm state, and an anxious state.

20. A method performed by circuitry of a system, the method comprising:
receiving, via a packet-switched network, input data from a client terminal, the input data comprising at least one of text data, image data, or link data associated with a posting operation by a user;
generating a feature vector by applying an encoder neural network to the input data, the encoder neural network comprising a multi-layer self-attention mechanism that produces a multidimensional tensor representation of the input data;
computing a classification score by calculating a similarity metric between the feature vector and a plurality of reference vectors stored in a database, each reference vector corresponding to a previously verified data entry;
generating annotation data based on the classification score, the annotation data comprising at least one of a label indicating a confidence level of the input data or supplementary text derived from a subset of the reference vectors having similarity metrics exceeding a threshold; and
transmitting the annotation data to the client terminal via the packet-switched network, the annotation data causing the client terminal to render the annotation data in association with the input data on a display of the client terminal.
